(19) United States
(12) Patent Application Publication
(10) Pub. No.: US 2005/0026785 A1
(43) Pub. Date: Feb. 3, 2005

(54) Novel phenyl-propargylether derivatives

(76) Inventors: Martin Zeller, Muenchwilen (CH); Clemens Lamberth, Basel (DE)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/495,153

(22) PCT Filed: Nov. 15, 2002
(86) PCT No.: PCT/EP02/12848

(30) Foreign Application Priority Data
Nov. 16, 2001 (GB) 0127554.4

(51) Int. Cl. A01N 25/00; A01N 57/18; A01N 37/18

(52) U.S. Cl. 504/204; 504/334; 564/155

(57) ABSTRACT

The invention relates to phenyl-propargylether derivatives of the general formula I including the optical isomers thereof and mixtures of such osimers, wherein R₁ is hydrogen, alkyl, cycloalkyl or optionally substituted aryl, R₂ and R₃ are each independently hydrogen or alkyl, R₄ is alkyl, alkenal or alkynyl, R₅, R₆, R₇, and R₈ are each independently hydrogen or alkal, R₉ is hydrogen, optionally substituted alkyl, optionnaly substituted alkenyl or optionally substituted alkynyl, R₁₀ is optionally substituted aryl or optionaly substituted heteroaryl, and Z is optionally substituted aryloxy, optionally substituted alkoxy, optionally substituted alkenyloxy or optionally substituted alkynyloxy. These compounds possess useful plant protecting properties and may advantageously be employed in agricultural practice for controlling or preventing the infestation of plants by phytopathogenic microorganisms, especially fungi.

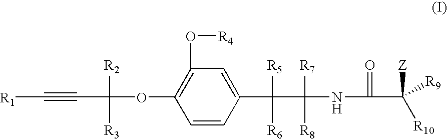

The present invention relates to novel enantiomeric forms of phenyl-propargylether derivatives of formula I below. It relates to the preparation of those enantiomeric substances and to agrochemical compositions comprising at least one of the compounds of formula I as active ingredient. The invention relates also to the preparation of the said compositions and to the use of the compounds or of the compositions in controlling or preventing the infestation of plants by phytopathogenic microorganisms, especially fungi.

The invention relates to phenyl-propargylether derivatives of the general formula I 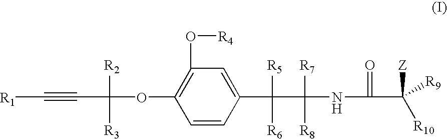
including the optical isomers thereof and mixtures of such isomers, wherein
R₁ is hydrogen, alkyl, cycloalkyl or optionally substituted aryl,
R₂ and R₃ are each independently hydrogen or alkyl,
R₄ is alkyl, alkenyl or alkynyl,
R₅, R₆, R₇, and R₈ are each independently hydrogen or alkyl,
R₉ is hydrogen, optionally substituted alkyl, optionally substituted alkenyl or optionally substituted alkynyl,
R₁₀ is optionally substituted aryl or optionally substituted heteroaryl, and
Z is optionally substituted aryloxy, optionally substituted alkoxy, optionally substituted alkenyloxy or optionally substituted alkynyloxy

The compounds of formula I is understood to encompass the pure enantiomer of the displayed formula I as well as substantially enantio-enriched forms, as usually obtained from large scale synthesis processes. The asymmetrical carbon atom to which the enantiomeric form of present invention relates is the alpha-carbon atom in the carboxylic acid, forming the amide function in the compounds of formula I. This carbon atom is marked in formula I with the indication of the absolute configuration according to the Cahn-Ingold-Prelog rules. For example, where R₉ is hydrogen, R₁₀ is the optionally substituted phenyl moiety, and Z is any defined radical, the asymmetrically substituted carbon atom is in the (S)-configuration.

The enantio-enriched forms according to present invention contain 70% or more of the pure enantiomer of formula I, while the difference to 100% of the compound of formula I is the mirror-image enantiomer. In contrast to present invention, the formerly known compounds of formula have been obtained in racemic forms, with in general comprised about equal amounts of the two enantiomer forms. In preferred embodiments of this invention the amount of the enantiomer in the compounds of formula I is above 80%, more preferred above 90%, especially above 95%, for example 97%, 98% or 99%.

The presence of more asymmetrical carbon atoms in the compounds of formula I, in addition to the alpha-carbon atom of the carboxylic, means that the enantiomers of compounds of formula I can occur in stereoisomeric forms, i.e. as several diastereomers. As a result of the presence of a possible aliphatic C═C double bond, also geometric isomerism may also occur. Formula I is intended to include all those possible diastereomeric forms of the enantiomer of formula I, and mixtures thereof.

Where the definition of formula I refers to optical isomers, for this document it shall be understood that the optical isomers are only those isomers which result from other possible asymmetrical elements in the molecule, if present, but not to the carbon atom in alpha-position of the amide functional group which is defined with its absolute configuration.

In the above definition aryl includes aromatic hydrocarbon rings like phenyl, naphthyl, anthracenyl, phenanthrenyl and biphenyl like 1,3-biphenyl and 1,4-biphenyl, with phenyl being preferred. The same definition applies where aryl is part of aryloxy or arylthio. Heteroaryl stands for aromatic ring systems comprising mono-, bi- or tricyclic systems wherein at least one oxygen, nitrogen or sulfur atom is present as a ring member. Examples are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, quinolinyl, isoquinolinyl, phthalazinyl, quinoxalinyl, quinazolinyl, cinnolinyl and naphthyridinyl.

The above aryl and heteroaryl groups may be optionally substituted. This means that they may carry one or more identical or different substituents. Normally not more than three substituents are present at the same time. Examples of substituents of aryl or heteroaryl groups are: alkyl, alkenyl, alkynyl, cycloalkyl, cycloalkyl-alkyl, phenyl and phenyl-alkyl, it being possible in turn for all of the preceding groups to carry one or more identical or different halogen atoms; alkoxy; alkenyloxy; alkynyloxy; alkoxyalkyl; haloalkoxy, alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; or alkynyloxycarbonyl. Typical examples include 4-chlorophenyl, 4-bromophenyl, 3,4-dichlorophenyl, 4-chloro-3-fluorophenyl, 3-chloro-4-fluorophenyl, 4-methylphenyl, 4-ethylphenyl, 4-propargyloxyphenyl, 1-naphtyl, 2-naphtyl, 4-biphenylyl, 4′-chloro-4-biphenylyl, 5-chloro-thien2-yl, 5-methyl-thien-2-yl, 5-methyl-fur-2-yl, 5,6,7,8-tetrahydro-1-naphthyl, 5,6,7,8-tetrahydro-2-naphthyl, 3,4dioxomethylenyl-phenyl, 3,4-dioxoethylenyl-phenyl, 6-benzothienyl, 7-benzothienyl, 3-methylphenyl, 4-fluorophenyl, 4-ethenylphenyl, 4-ethynylphenyl, 4-propylphenyl, 4-isopropylphenyl, 4-tert-butylphenyl, 4-ethoxyphenyl, 4-ethynyloxyphenyl, 4-phenoxyphenyl, 4-methylthiophenyl, 4-methylsulfonylphenyl, 4-cyanophenyl, 4-nitrophenyl, 4-methoxycarbonylphenyl, 3-bromophenyl, 3-chlorophenyl, 2-chlorophenyl, 2,4-dichlorophenyl, 3,4,5-trichlorophenyl, 3,4-difluorophenyl, 3,4-dibromophenyl, 3,4-dimethoxyphenyl, 3,4-dimethylphenyl, 3-chloro-4-cyanophenyl, 4-chloro-3-cyanophenyl, 3-bromo-4-methylphenyl, 4-methoxy-3-methylphenyl, 3-fluoro-4-methoxyphenyl, 4-chloro-3-methylphenyl, 4-chloro-3-trifluoromethyl-phenyl, 4-bromo-3-chlorophenyl, 4-trifluoromethylphenyl, 4-trifluoromethoxyphenyl, 4-methoxyphenyl, 4′-methyl-4-biphenylyl, 4′-trifluoromethyl-4-biphenylyl, 4′-bromo-4-biphenylyl, 4′-cyano-4-biphenylyl, 3′4′-dichloro-4-biphenylyl, etc.

Again, the same optional substituent may be present where aryl is part of aryloxy. Optionally substituted alkyl, alkenyl or alkynyl groups may carry one or more substituents selected from halogen, alkyl, alkoxy, alkylthio, cycloalkyl, phenyl, nitro, cyano, hydroxy, mercapto, alkylcarbonyl or alkoxycarbonyl. This also applies where alkyl, alkenyl or alkynyl is part of another substituent like alkoxy, alkylthio, alkylsulfinyl, alkylsulfonyl, alkenylyoxy, alkenylthio, alkenylsulfinyl, alkenylsufonyl, alkynyloxy, alkynylthio, alkynylsulfinyl and alkynylsulfonyl.

Preferably, the number of substituents is no more than three with the exception of halogen, where the alkyl groups may be perhalogenated.

In the above definitions “halogen” includes fluorine, chlorine, bromine and iodine. The alkyl, alkenyl and alkynyl radicals may be straight-chain or branched. This applies also to the alkyl, alkenyl or alkynyl parts of other alkyl-, alkenyl- or alkynyl-containing groups. Depending upon the number of carbon atoms mentioned, alkyl on its own or as part of another substituent is to be understood as being, for example, methyl, ethyl, propyl, butyl, pentyl, hexyl, heptyl, octyl, nonyl, decyl, undecyl, dodecyl and the isomers thereof, for example isopropyl, isobutyl, tert-butyl or sec-butyl, isopentyl or tert-pentyl. Cycloalkyl is, depending upon the number of carbon atoms mentioned, cyclopropyl, cyclobutyl, cyclopentyl, cyclohexyl, cycloheptyl or cyclooctyl.

Depending upon the number of carbon atoms mentioned, alkenyl as a group or as a structural element of other groups is to be understood as being, for example —CH═CH₂, —CH₂—CH═CH₂, —CH═CH—CH₃, —CH₂—CH═CH—CH₃, —CH₂—CH₂—CH═CH₂, —CH₂—CH(CH₃)—CH═CH₂, —CH₂—C(CH₃)═CH₂, —CH═CH—(CH₂)₂—CH₃, —CH₂—CH₂—CH═CH—CH₃, —CH₂—CH₂—C(CH₃)═CH—CH₃, —CH(CH₃)—CH₂—CH═CH—CH₃, —CH₂—CH₂—CH═CH—CH₂—CH₃, —CH═CH—(CH₂)₃—CH₃, —CH₂—CH₂—CH═C(CH₃)—CH₃, —CH₂—CH₂—CH═C(CH₃)—CH₂—CH₃, —C(CH₃)═CH₂, —CH(CH₃)—CH═CH₂, —C(CH₃)═CH—CH₃, —CH(CH₃)—CH═CH—CH₃, —CH(CH₃)—CH₂—CH═CH₂, —CH₂—CH(CH₃)—C(CH₃)═CH₂, —CH₂—C(CH₃)═CH—CH₃—C(CH₃)═CH—(CH₂)₂—CH₃, —CH(CH₃)—CH₂—C(CH₃)═CH—CH₃, —CH(CH₃)—(CH₂)₂—CH═CH₂, —CH(CH₃)—CH₂—CH═CH—CH₂—CH₃, —C(CH₃)═CH—(CH₂)₃—CH₃, —(CH₂)₃—CH═CH₂, —CH(CH₃)—CH₂—C(CH₃)═CH—CH₃, or —CH(CH₃)—CH₂—CH═CH—CH₂—CH₃. Alkynyl as a group or as a structural element of other groups is, for example —C≡CH, —CH₂—C≡CH, —C≡C—CH₃, —CH₂—C≡C—CH₃, —CH₂—CH₂—C≡CH, —C≡C—CH₂—CH₃, —CH₂—CH(CH₃)—C≡CH, —C≡C—(CH₂)₂—CH₃, —CH₂—CH₂—C≡C—CH₃, —CH(CH₃)—CH₂C≡C—CH₃, —CH₂—CH₂—C≡C—CH₂—CH₃, —C≡C—(CH₂)₃—CH₃, —C≡C—(CH₂)₄—CH₃, —CH(CH₃)—C≡CH, —CH(CH₃)—C≡C—CH₃, —CH(C₂H₅)—C≡C—CH₃, —CH(CH₃)—CH₂—C≡CH, —CH(CH₃)—(CH₂)₂—C≡CH, —CH(CH₃)—CH₂—C≡C—CH₂—CH₃, —(CH₂)₃—C≡CH, or —CH(CH₃)—CH₂—C≡C—CH₂—CH₃, depending on the number of carbon atoms present.

A haloalkyl group may contain one or more (identical or different) halogen atoms, and for example may stand for CHCl₂, CH₂F, CCl₃, CH₂Cl, CHF₂, CF₃, CH₂CH₂Br, C₂Cl₅, CH₂Br, CHClBr, CF₃CH₂, etc.

Preferred subgroups of compounds of formula I are those wherein

R₁ is hydrogen, alkyl, cycloalkyl, phenyl or naphthyl; phenyl and naphthyl being optionally substituted by substituents selected from the group comprising alkyl, alkenyl, alkynyl, cycloalkyl, cycloalkyl-alkyl, phenyl and phenylalkyl, where all these groups may in turn be substituted by one or several halogens; alkoxy; alkenyloxy; alkynyloxy; alkoxy-alkyl; haloalkoxy; alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; or alkynyloxycarbonyl; or

R₁ is hydrogen, C₁-C₈alkyl, C₃-C₈cycloalkyl, phenyl or naphthyl; phenyl and naphthyl being optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; or

R₁ is hydrogen, C₁-C₈alkyl or phenyl optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; or

R₁ is hydrogen, C₁-C₈alkyl or C₃-C₈cycloalkyl; or

R₁ is hydrogen or C₁-C₄alkyl; or

R₂ and R₃ are independently of each other hydrogen or C₁-C₄alkyl; or

R₂ and R₃ are hydrogen; or

R₄ is C₁-C₈alkyl, C₂-C₈alkenyl, or C₂-C₈alkynyl; or

R₄ is C₁-C₆alkyl; or

R₄ is C₁-C₄alkyl, or

R₄ is methyl or ethyl, especially methyl; or

R₅, R₆, R₇ and R₈ are independently of each other hydrogen or C₁-C₄alkyl; or

R₅, R₆ and R₇ are hydrogen and R₈ is hydrogen, methyl or ethyl, preferably methyl; or

R₅, R₆, R₇ and R₈ are hydrogen; or

R₉ is hydrogen, C₁-C₄alkyl, C₁-C₄haloalkyl, C₃-C₄alkenyl or C₃-C₄alkynyl; or

R₉ is hydrogen or C₁-C₄alkyl; or

R₉ is hydrogen; or

R₁₀ is aryl or heteroaryl, each optionally substituted with substituents selected from the group comprising alkyl, alkenyl, alkynyl, cycloalkyl, cycloalkyl-alkyl, phenyl and phenylalkyl, where all these groups may be substituted with one or more halogen atoms; alkoxy; alkenyloxy; alkynyloxy; alkoxy-alkyl; haloalkoxy; alkylthio; haloalkylthio; alkylsulfonyl; formyl; alkanoyl; hydroxy; cyano; nitro; amino; alkylamino; dialkylamino; carboxyl; alkoxycarbonyl; alkenyloxycarbonyl and alkynyloxycarbonyl; or

R₁₀ is phenyl, naphthyl or biphenyl, each optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; or

R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; or

Z is optionally substituted aryloxy wherein the aryl may be optionally substituted by one or more substituents selected from the group comprising halogen, C₁-C₈alkoxy, C₂-C₈alkenyloxy, C₂-C8alkynyloxy, C₁-C₈alkoxy-C₁-C₈alkyl, C₁-C₈haloalkoxy, C₁-C₈alkylthio, C₁-C₈haloalkylthio, C₁-C₈alkylsulfonyl, formyl, C₂-C₈alkanoyl, hydroxy, halogen, cyano, nitro, amino, C₁-C₈alkylamino, di-C₁-C₈alkylamino, carboxyl and C₁-C₈alkoxycarbonyl; or is optionally substituted C₁-C₈alkoxy, optionally substituted C₂-C₈alkenyloxy or optionally substituted C₂-C₈alkynyloxy wherein each alkyl, alkenyl or alkynyl group may carry one or more substituents selected from the group comprising halogen, C₁-C₄alkyl, C₁-C₄alkoxy, C₁-C₄alkylthio, C₃-C₆cycloalkyl, nitro, cyano, hydroxy, phenyl, mercapto, C₁-C₄alkylcarbonyl and C₁-C₄alkoxycarbonyl; or

Z is C₁-C₈alkoxy, C₂-C₈alkenyloxy, C₂-C₈alkynyloxy, C₁-C₈alkoxy-C₁-C₈alkoxy, C₂-C₈alkenyloxy-C₁-C₈alkoxy, C₂-C₈alkynyloxy-C₁-C₈alkoxy, C₁-C₈haloalkoxy or C₃-C₈cycloalkyl-C₁-C₈alkoxy; or

Z is C₁-C₈alkoxy, C₂-C₈alkenyloxy, C₂-C₈alkynyloxy or C₁-C₄alkoxy-C₁-C₂alkoxy; or

Z is C₁-C₈alkoxy, C₂-C₆alkenyloxy or C₂-C₆alkynyloxy.

One preferred subgroup of the compounds of formula I consists of those compounds wherein R₉ is hydrogen, and Z is C₁-C₈alkoxy, C₂-C₆alkenyloxy or C₂-C₆alkynyloxy.

Further preferred subgroups are those wherein

R₁ is hydrogen, alkyl, cycloalkyl, phenyl or naphthyl; phenyl and naphthyl being optionally substituted by substituents selected from the group comprising alkyl, alkenyl, alkynyl, cycloalkyl, cycloalkyl-alkyl, phenyl and phenylalkyl, where all these groups may in turn be substituted by one or several halogens; alkoxy, alkenyloxy, alkynyloxy; alkoxy-alkyl; haloalkoxy; alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; or alkynyloxycarbonyl; and R₄ is alkyl; and R₁₀ is aryl or heteroaryl, each optionally substituted by substituents selected from to group comprising alkyl, alkenyl, alkynyl, cycloalkyl, cycloalkylalkyl, phenyl and phenylalkyl, where all these groups may be substituted by one or several halogen; alkoxy; alkenyloxy; alkynyloxy; alkoxy-alkyl; haloalkoxy; alkylthio; haloalkylthio; alkylsulfonyl; formyl; alkanoyl; hydroxy; cyano; nitro; amino; alkylamino; dialkylamino; carboxyl; alkoxycarbonyl; alkenyloxycarbonyl and alkynyloxycarbonyl; and Z is C₁-C₈alkoxy, C₂-C₆alkenyloxy or C₂-C₆alkynyloxy; or

R₁ is hydrogen, C₁-C₈alkyl, C₃-C₈cycloalkyl, phenyl or naphthyl; phenyl and naphthyl being optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; and R₂, R₃, R₅, R₆, and R₇ are hydrogen; and R₄ and R₈ are independently C₁-C₆alkyl; and R₁₀ is phenyl, naphthyl, 1,3-biphenyl or 1,4-biphenyl, each optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; and R₉ is hydrogen or C₁-C₄alkyl; and Z is C₁-C₈alkoxy, C₂-C₆alkenyloxy or C₂-C₆alkynyloxy; or

R₁ is hydrogen, C₁-C₈alkyl, phenyl optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and R₂, R₃, R₅, R₆, and R₇ are hydrogen; and R₄ and R₈ are each independently methyl or ethyl; and R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; R₉ is hydrogen and Z is C₁-C₈alkoxy, C₂-C₆alkenyloxy or C₂-C₆alkynyloxy.

Other preferred subgroups of the compounds of formula I are those wherein

R₁ is hydrogen, alkyl, cycloalkyl, phenyl or naphthyl; phenyl and naphthyl being optionally substituted by substituents selected from the group comprising alkyl, alkenyl, alkynyl, cycloalkyl, cycloalkyl-alkyl, phenyl and phenylalkyl, where all these groups may in turn be substituted by one or several halogens; alkoxy, alkenyloxy, alkynyloxy; alkoxy-alkyl; haloalkoxy; alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; or alkynyloxycarbonyl; and
R₂ and R₃ are independently of each other hydrogen or C₁-C₄alkyl; and
R₄ is C₁-C₈alkyl, C₂-C₈alkenyl, or C₂-C₈alkynyl; and
R₅, R₆, R₇ and R₈ are independently of each other hydrogen or C₁-C₄alkyl; and
R₉ is hydrogen, C₁-C₄alkyl, C₁-C₄haloalkyl, C₃-C₄alkenyl or C₃-C₄alkynyl; and
R₁₀ is aryl or heteroaryl, each optionally substituted with substituents selected from to group comprising alkyl, alkenyl, alkynyl, cycloalkyl, cycloalkyl-alkyl, phenyl and phenylalkyl, where all these groups may be substituted with one or more substituents selected from the group comprising halogen; alkoxy, alkenyloxy, alkynyloxy; alkoxy-alkyl; haloalkoxy; alkylthio; haloalkylthio; alkylsulfonyl; formyl; alkanoyl; hydroxy; cyano; nitro; amino; alkylamino; dialkylamino; carboxyl; alkoxycarbonyl; alkenyloxycarbonyl and alkynyloxycarbonyl; and
Z is optionally substituted aryloxy wherein in each the aryl may be optionally subsbtuted by one or more substituents selected from the group comprising halogen, C₁-C₈alkoxy, C₂-C₈alkenyloxy, C₂-C8alkynyloxy, C₁-C₈alkoxy-C₁-C₈alkyl, C₁-C₈haloalkoxy, C₁-C₈alkylthio, C₁-C₈haloalkylthio, C₁-C₈alkylsulfonyl, formyl, C₂-C₈alkanoyl, hydroxy, halogen, cyano, nitro, amino, C₁-C₈alkylamino, di-C₁-C₈alkylamino, carboxyl and C₁-C₈alkoxycarbonyl; or is optionally substituted C₁-C₈alkoxy, optionally substituted C₂-C₈alkenyloxy or optionally substituted C₂-C₈alkynyloxy, wherein each alkyl, alkenyl or alkynyl group may carry one or more substituents selected from the group comprising halogen, C₁-C₄alkyl, C₁-C₄alkoxy, C₁-C₄alkylthio, C₃-C₆cycloalkyl, nitro, cyano, hydroxy, phenyl, mercapto, C₁-C₄alkylcarbonyl and C₁-C₄alkoxycarbonyl; or wherein

R₁ is hydrogen, C₁-C₈alkyl, C₃-C₈cycloalkyl, phenyl or naphthyl; phenyl and naphthyl being optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C8alkylthio, C₁-C₈haloalkylthio, C₁-C₈alkylsulfonyl, halogen, cyano, nitro and C₁-C₈alkoxycarbonyl; and
R₂ and R₃ are hydrogen; and
R₄ is C₁-C₆alkyl; and
R₅, R₆ and R₇ are hydrogen and R₈ is hydrogen, methyl or ethyl, preferably methyl; and
R₉ is hydrogen or C₁-C₄alkyl; and
R₁₀ is phenyl, naphthyl or biphenyl, each optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; and
Z is C₁-C₈alkoxy, C₂-C₈alkenyloxy, C₁-C₈alkynyloxy, C₁-C₈alkoxy-C₁-C₈alkoxy, C₂-C₈alkenyloxy-C₁-C₈alkoxy, C₂-C₈alkynyloxy-C₁-C₈alkoxy, C₁-C₈haloalkoxy or C₃-C₈cycloalkyl-C₁-C₈alkoxy; or wherein

R₁ is hydrogen, C₁-C₈alkyl or phenyl optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and
R₂ and R₃ are hydrogen; and
R₄ is C₁-C₄alkyl, and
R₅, R₆ and R₇ are hydrogen and R₈ is hydrogen or methyl; and
R₉ is hydrogen; and
R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and
Z is C₁-C₈alkoxy, C₂-C₈alkenyloxy, C₂-C₈alkynyloxy or C₁-C₄alkoxy-C₁-C₂alkoxy; or wherein

R₁ is hydrogen, C₁-C₈alkyl or C₃-C₈cycloalkyl; and
R₂, R₃, R₅, R₆, R₇, R₈ and R₉ are hydrogen; and
R₄ is methyl or ethyl; and
R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and
Z is C₁-C₈alkoxy, C₂-C₆alkenyloxy or C₂-C₆alkynyloxy.

Preferred individual compounds are:
(S)-2-(4-bromo-phenyl)-2-methoxy-N-[2-(3-methoxy-4-prop-2-ynyloxy-phenyl)-ethyl]-acetamide,
(S)-2-(4-chloro-phenyl)-2-methoxy-N-[2-(3-methoxy-4-prop-2-ynyloxy-phenyl)-ethyl]-acetamide,
(S)-2-(3,4-dichloro-phenyl)-2-methoxy-N-[2-(3-methoxy-4-prop-2-ynyloxy-phenyl)-ethyl]-acetamide,
(S)-2-(4-bromo-phenyl)-2-ethoxy-N-[2-(3-methoxy-4-prop-2-ynyloxy-phenyl)-ethyl]-acetamide,
(S)-2-(4-chloro-phenyl)-2-ethoxy-N-[2-(3-methoxy-4-prop-2-ynyloxy-phenyl)-ethyl]-acetamide,
(S)-2-(3,4-dichloro-phenyl)-2-ethoxy-N-[2-(3-methoxy-4-prop-2-ynyloxy-phenyl)-ethyl]-acetamide,
(S)-2-(4-bromo-phenyl)-N-[2-(3-methoxy-4-prop-2-ynyloxy-phenyl)-ethyl]-2-propoxy-acetamide,
(S)-2-(4-chloro-phenyl)-N-[2-(3-methoxy-4-prop-2-ynyloxy-phenyl)-ethyl]-2-propoxy-acetamide,
(S)-2-(3,4-dichloro-phenyl)-N-[2-(3-methoxy-4-prop-2-ynyloxy-phenyl)-ethyl]-2-propoxy-acetamide,
(S)-2-(4-bromo-phenyl)-2-cyclopropylmethoxy-N-[2-(3-methoxy-4-prop-2-ynyloxy-phenyl)-ethyl]-acetamide,
(S)-2-(4-chloro-phenyl)-2-cyclopropylmethoxy-N-[2-(3-methoxy-4-prop-2-ynyloxy-phenyl)-ethyl]-acetamide,
(S)-2-cyclopropylmethoxy-2-(3,4-dichloro-phenyl)-N-[2-(3-methoxy-4-prop-2-ynyoxy-phenyl)-ethyl]-acetamide,
(S)-2-(4-bromo-phenyl)-2-ethoxymethoxy-N-[2-(3-methoxy-4-prop-2-ynyloxy-phenyl)-ethyl]-acetamide,
(S)-2-(4-chloro-phenyl)-2-ethoxymethoxy-N-[2-(3-methoxy-4-prop-2-ynyloxy-phenyl)-ethyl]-acetamide,
(S)-2-(3,4-dichloro-phenyl)-2-ethoxymethoxy-N-[2-(3-methoxy-4-prop-2-ynyloxy-phenyl)-ethyl]-acetamide,
(S)-2-allyloxy-2-(4-bromo-phenyl)-N-[2-(3-methoxy-4-prop-2-ynyloxy-phenyl)-ethyl]-acetamide,
(S)-2-allyloxy-2-(4-chloro-phenyl)-N-[2-(3-methoxy-4-prop-2-ynyloxy-phenyl)-ethyl]-acetamide,
(S)-2-allyloxy-2-(3,4-dichloro-phenyl)-N-[2-(3-methoxy-4-prop-2-ynyloxy-phenyl)-ethyl]-acetamide,
(S)-2-(4-bromo-phenyl)-2-(but-2-enyloxy)-N-[2-(3-methoxy-4-prop-2-ynyloxy-phenyl)-ethyl]-acetamide,
(S)-2-(but-2-enyloxy)-2-(4-chloro-phenyl)-N-[2-(3-methoxy-4-prop-2-ynyloxy-phenyl)-ethyl]-acetamide,
(S)-2-(but-2-enyloxy)-2-(3,4-dichloro-phenyl)-N-[2-(3-methoxy-4-prop-2-ynyloxy-phenyl)-ethyl]-acetamide,
(S)-2-(4-bromo-phenyl)-N-[2-(3-methoxy-4-prop-2-ynyloxy-phenyl)-ethyl]-2-prop-2-ynyloxy-acetamide,
(S)-2-(4-chloro-phenyl)-N-[2-(3-methoxy-4-prop-2-ynyloxy-phenyl)-ethyl]-2-prop-2-ynyloxy-acetamide,
(S)-2-(3,4-dichloro-phenyl)-N-[2-(3-methoxy-4-prop-2-ynyloxy-phenyl)-ethyl]-2-prop-2-ynyloxy-acetamide,
(S)-2-biphenyl-4-yl-N-[2-(3-methoxy-4-prop-2-ynyloxy-phenyl)-ethyl]-2-prop-2-ynyloxy-acetamide,
(S)-N-[2-(3-methoxy-4-prop-2-ynyloxy-phenyl)-ethyl]-2-naphthalen-2-y-2-prop-2-ynyloxy-acetamide,
(S)-N-[2-(3-methoxy-4-prop-2-ynyloxy-phenyl)-ethyl]-2-prop-2-ynyloxy-2-p-toly-acetamide, 2-(4-ethyl-phenyl)-N-[2-(3-methoxy-4-prop-2-ynyloxy-phenyl)-ethyl]-2-prop-2-ynyloxy-acetamide,
(S)-N-[2-(3-methoxy-4-prop-2-ynyloxy-phenyl)-ethyl]-2-prop-2-ynyloxy-2-(4-trifluoromethyl-phenyl)-acetamide,
(S)-2-(4-bromo-phenyl)-2-but-2-ynyloxy-N-[2-(3-methoxy-4-prop-2-ynyloxy-phenyl)-ethyl]-acetamide,
(S)-2-but-2-ynyloxy-2-(4-chloro-phenyl)-N-[2-(3-methoxy-4-prop-2-ynyloxy-phenyl)-ethyl]-acetamide,
(S)-2-but-2-ynyloxy-2-(3,4-dichloro-phenyl)-N-[2-(3-methoxy-4-prop-2-ynyloxy-phenyl)-ethyl]acetamide,
(S)-2-(4-bromo-phenyl)-N-[2-(3-methoxy-4-pent-2-ynyloxy-phenyl)-ethyl]-2-prop-2-ynyloxy-acetamide,
(S)-2-(4-chloro-phenyl)-N-[2-(3-methoxy-4-pent-2-ynyloxy-phenyl)-ethyl]-2-prop-2-ynyloxy-acetamide,
(S)-2-(3,4-dichloro-phenyl)-N-[2-(3-methoxy-4-pent-2-ynyloxy-phenyl)-ethyl]-2-prop-2-ynyloxy-acetamide,
(S)-2-(4fluoro-phenyl)-N-[2-(3-methoxy-4-prop-2-ynyloxy-phenyl)-ethyl]-2-prop-2-ynyloxy-acetamide,
(S)-2-(3,4-difluoro-phenyl)-N-[2-(3-methoxy-4-prop-2-ynyloxy-phenyl)-ethyl]-2-prop-2-ynyloxy-acetamide,
(S)-2-(4-chloro-3-fluoro-phenyl)-N-[2-(3-methoxy-4-prop-2-ynyloxy-phenyl)-ethyl]-2-prop-2-ynyloxy-acetamide, and
(S)-2-(3-chloro-4-fluoro-phenyl)-N-[2-(3-methoxy-4-prop-2-ynyloxy-phenyl)-ethyl]-2-prop-2-ynyloxy-acetamide.

Certain racemic mandelic acid derivatives have been proposed for controlling plant-destructive fungi (for example in WO 94/29267, in WO 96/17840 and in PCT/EP01/05530). The action of those racemic derivatives is not, however, satisfactory in all aspects of agricultural needs. Surprisingly, with the enantiomeric form of the compounds of formula I, new microbiocides having a high level of activity have been found.

The enantiomeric propargylether derivatives of formula I and displayed subformulae and intermediates may be obtained either by separation methods from the racemic products having the same molecular design, or by stereoselective synthesis methods starting from optically active pure isomers of the starting materials via defined stereoselective processes and pure optical isomers of the intermediates according to one of the processes of Schemes 1 and 2.

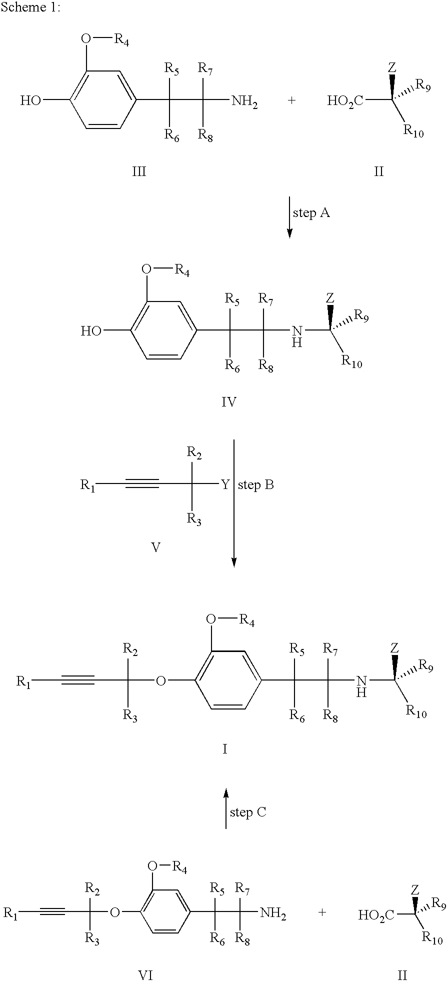

Step A: The acid of formula II or a carboxy-activated derivative of an acid of formula II wherein R₉, R₁₀ and Z are as defined for formula I is reacted with an amine of formula IlI wherein R₄, R₅, R₆, R₇ and R₈ are as defined for formula I, optionally in the presence of a base and optionally in the presence of a diluting agent.

Carboxy-activated derivatives of the acid of formula II are all compounds having an activated carboxyl group like an acid halide, such as an acid chloride, like symmetrical or mixed anhydrides, such as mixed anhydrides with O-alkylcarbonates, like activated esters, such as p-nitrophenylesters or N-hydroxysuccinimidesters, as well as in-situ-formed activated forms of the acid of formula II with condensating agents, such as dicyclohexylcarbodiimide, carbonyldiimidazole, benzotriazol-1-yloxy-tris(dimethylamino)phosphonium hexafluorophosphate, O-benzotriazol-1-yl-N,N,N′,N′-bis(pentamethylene)uronium hexafluorophosphate, O-benzotriazol -1-yl-N,N,N′,N′-bis(tetramethylene)uronium hexafluorophosphate, O-benzotriazol-1-yl-N,N,N′,N′-tetramethyluronium hexafluorophosphate or benzotriazol-1-yloxy-tripyrrolidinophosphonium hexafluorophosphate. The mixed anhydrides of the acids of the formula II may be prepared by reaction of an acid of formula II with chloroformic acid esters like chloroformic acid alkylesters, such as ethyl chloroformate or isobutyl chloroformate, optionally in the presence of an organic or inorganic base like a tertiary amine, such as triethylamine, N,N-diisopropyl-ethylamine, pyridine, N-methyl-piperidine or N-methyl-morpholine.

The present reaction is preferably performed in a solvent like aromatic, non-aromatic or halogenated hydrocarbons, such as chlorohydrocarbons e.g. dichloromethane or toluene; ketones e.g. acetone; esters e.g. ethyl acetate; amides e.g. N,N-dimethylformamide; nitriles e.g. acetonitrile; or ethers e.g. diethylether, tert-butyl-methylether, dioxane or tetrahydrofurane or water. It is also possible to use mixtures of these solvents. The reaction is performed optionally in the presence of an organic or inorganic base like a tertiary amine, e.g. triethylamine, N,N-diisopropyl-ethylamine, pyridine, N-methyl-piperidine or N-methylmorpholine, like a metal hydroxide or a metal carbonate, preferentially an alkali hydroxide or an alkali carbonate, such as lithium hydroxide, sodium hydroxide or potassium hydroxide at temperatures ranging from −80° C. to +150° C., preferentially at temperatures ranging from −40° C. to +40° C.

Step B: The compounds of formula I may then finally be prepared by reacting a phenol of formula IV wherein R₄, R₅, R₆, R₇, R₈, R₉, R₁₀ and Z are as defined for formula I with a compound of formula V wherein R₁, R₂ and R₃ are as defined for formula I and wherein Y is a leaving group like a halide such as a chloride or bromide or a sulfonic ester such as a tosylate, mesylate or triflate.

The reaction is advantageously performed in a solvent like aromatic, non-aromatic or halogenated hydrocarbons, such as chlorohydrocarbons e.g. dichloromethane or toluene; ketones e.g. acetone or 2-butanone; esters e.g. ethyl acetate; ethers e.g. diethylether, tert-butyl-methylether, dioxane or tetrahydrofurane, amides e.g. dimethylformamide, nitriles e.g. acetonitrile, alcohols e.g. methanol, ethanol, isopropanol, n-butanol or tert-butanol, sulfoxides e.g. dimethylsulfoxide or water. It is also possible to use mixtures of these solvents. The reaction is performed optionally in the presence of an organic or inorganic base like a tertiary amine, such as triethylamine, N,N-diisopropyl-ethylamine, pyridine, N-methyl-piperidine or N-methyl-morpholine, like a metal hydroxide, a metal carbonate or a metal alkoxide, preferentially an alkali hydroxide, an alkali carbonate or an alkali alkoxide, such as lithium hydroxide, sodium hydroxide, potassium hydroxide, sodium carbonate, potassium carbonate, sodium methoxide, potassium methoxide, sodium ethoxide, potassium ethoxide, sodium tert-butoxide or potassium tert-butoxide at temperatures ranging from −80° C. to +200° C., preferentially at temperatures ranging from 0° C. to +120° C.

Step C: Alternatively to step A and step B, the (S)-form of an acid of formula II or a carboxy-activated derivative of an acid of formula II wherein R₉, R₁₀ and Z are as defined for formula I is reacted with an amine of formula VI wherein R₁, R₂, R₃, R₄, R₅, R₆, R₇ and R₈ are as defined for formula I under the same conditions as defined for step A, optionally in the presence of a base and optionally in the presence of a diluting agent.

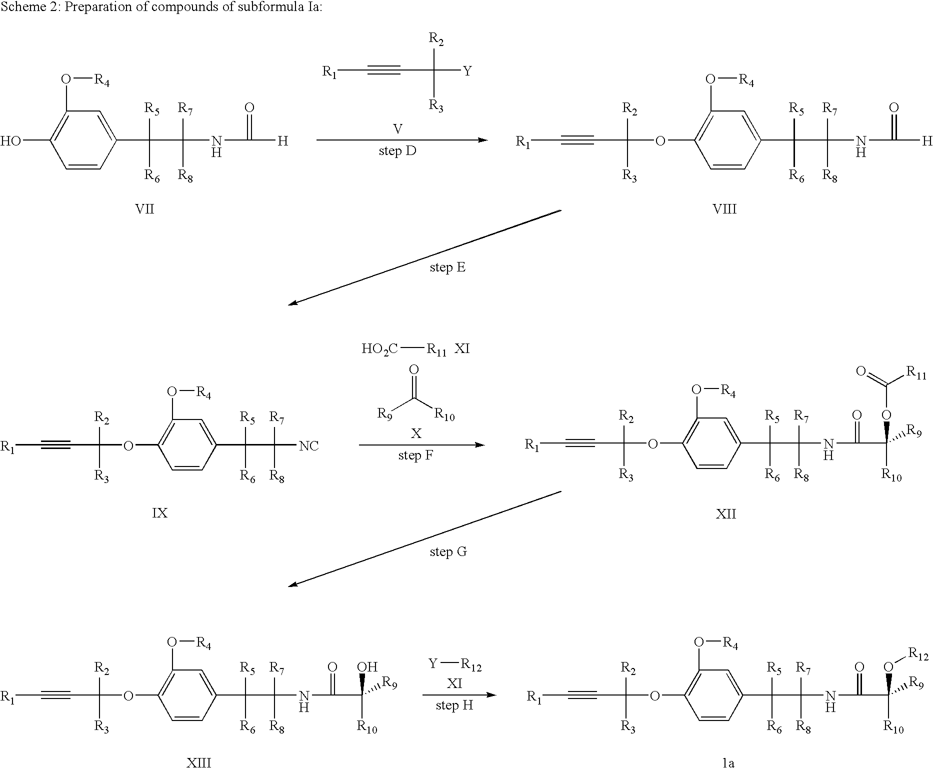

Step D: A compound of formula VII wherein R₄, R₅, R₆, R₇ and R₈ are as defined for formula I is alkylated with a compound of formula V (see Scheme 1) wherein R₁, R₂, R₃ and Y are as defined for Scheme 1 under the same conditions as defined for step B in Scheme 1.

Step E: A compound of formula VIII wherein R₁, R₂, R₃, R₄, R₅, R₆, R₇ and R₈ are as defined for formula I is dehydrated to an isocyanide of formula IX wherein R₁, R₂, R₃, R₄, R₅, R₆, R₇ and R₈ are as defined for formula I under conditions known per se (D. Seebach, G. Adam, T. Gees, M. Schiess, W. Weigang, Chem. Ber. 1988, 121, 507).

Step F: An isocyanide of formula IX wherein R₁, R₂, R₃, R₄, R₅, R₆, R₇ and R₈ are as defined for formula I is reacted in a three-component Passerini reaction (J. March, Advanced Organic Chemistry, 4th ed., Wiley, 1992, p. 980) with an aldehyde or ketone of formula X, wherein R₉ and R₁₀ are as defined for formula I in the presence of a chiral carboxylic acid XI, typically an amino acid or a sugar acid like a gluconic acid or a glycuronic acid, preferably a glycuronic acid like 1,2,3,4-tetra-O-acetyl-a-D-galacturonic acid or 1,2,3,4-tetra-O-acetyl-α-D-glucuronic acid to give a O-acyl-α-hydroxy amide of formula XII, wherein R₁, R₂, R₃, R₄, R₅, R₆, R₇, R₈, R₉ and R₁₀ are as defined for formula I. The reaction is advantageously performed in a solvent like aromatic, non-aromatic or halogenated hydrocarbons, such as chlorohydrocarbons e.g. dichloromethane or toluene; ketones e.g. acetone or 2-butanone; esters e.g. ethyl acetate; ethers e.g. diethylether, tert-butyl-methylether, dioxane or tetrahydrofuran, amides e.g. dimethylformamide, nitriles e.g. acetonitrile, alcohols e.g. methanol, ethanol, isopropanol, n-butanol or tert-butanol, sulfoxides e.g. dimethylsulfoxide or water. It is also possible to use mixtures of these solvents.

Step G: The O-acyl-α-hydroxy amide of formula XII wherein R₁, R₂, R₃, R₄, R₅, R₆, R₇, R₈, R₉, R₁₀ and R₁₁ are as defined above is hydrolyzed to a an α-hydroxy amide of formula XIII, wherein R₁, R₂, R₃, R₄, R₅, R₆, R₇, R₈, R₉ and R₁₀ are as defined for formula I under classical conditions (J. March, Advanced Organic Chemistry, 4th ed., Wiley, 1992).

Step H: The α-hydroxy amide of formula XIII wherein R₁, R₂, R₃, R₄, R₅, R₆, R₇, R₈, R₉ and R₁₀ are as defined for formula I is reacted with a compound XIV wherein R₁₂ is alkyl, alkenyl or alkynyl and Y is a leaving group like a halide such as a chloride or bromide or a sulfonic ester such as a tosylate, mesylate or triflate to a compound of formula Ia wherein R₁, R₂, R₃, R₄, R₅, R₆, R₇, R₈, R₉ and R₁₀ are as defined for formula I and R₁₂ is alkyl, alkenyl or alkynyl under the same conditions as defined for step B in Scheme 1.

The compounds of formula I are oils or solids at room temperature and are distinguished by valuable microbiocidal properties. They can be used in the agricultural sector or related fields preventatively and curatively in the control of plant-destructive microorganisms. The compounds of formula I according to the invention are distinguished at low rates of concentration not only by outstanding microbiocidal, especially fungicidal, activity but also by being especially well tolerated by plants.

Surprisingly, it has now been found that the compounds of formula I have for practical purposes a very advantageous microbiocidal spectrum in the control of phytopathogenic microorganisms, especially fungi. They possess very advantageous curative and preventive properties and are used in the protection of numerous crop plants. With the compounds of formula I it is possible to inhibit or destroy phytopathogenic microorganisms that occur on various crops of useful plants or on parts of such plants (fruit, blossom, leaves, stems, tubers, roots), while parts of the plants which grow later also remain protected, for example, against phytopathogenic fungi.

The novel compounds of formula I prove to be effective against specific genera of the fungus class Fungi imperfecti (e.g. Cercospora), Basidiomycetes (e.g. Puccinia) and Ascomycetes (e.g. Erysiphe and Venturia) and especially against Oomycetes (e.g. Plasmopara, Peronospora, Pythium and Phytophthora). They therefore represent in plant protection a valuable addition to the compositions for controlling phytopathogenic fungi. The compounds of formula I can also be used as dressings for protecting seed (fruit, tubers, grains) and plant cuttings from fungal infections and against phytopathogenic fungi that occur in the soil.

The invention relates also to compositions comprising compounds of formula I as active ingredient, especially plant-protecting compositions, and to the use thereof in the agricultural sector or related fields.

In addition, the present invention includes the preparation of those compositions, wherein the active ingredient is homogeneously mixed with one or more of the substances or groups of substances described herein. Also included is a method of treating plants which is distinguished by the application of the novel compounds of formula I or of the novel compositions.

Target crops to be protected within the scope of this invention comprise, for example, the following species of plants: cereals (wheat, barley, rye, oats, rice, maize, sorghum and related species); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucurbitaceae (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamon, camphor) and plants such as tobacco, nuts, coffee, sugar cane, tea, pepper, vines, hops, bananas and natural rubber plants, and also ornamentals.

The compounds of formula I are normally used in the form of compositions and can be applied to the area or plant to be treated simultaneously or in succession with other active ingredients. Those other active ingredients may be fertilisers, micronutrient donors or other preparations that influence plant growth. It is also possible to use selective herbicides or insecticides, fungicides, bactericides, nematicides, molluscicides or mixtures of several of those preparations, if desired together with further carriers, surfactants or other application-promoting adjuvants customarily employed in formulation technology.

The compounds of formula I can be mixed with other fungicides, resulting in some cases in unexpected synergistic activities. Such mixtures are not limited to two active ingredients (one of formula I and one of the list of other fungicides), but to the contrary many comprise more than one active ingredient of the component of formula I and more than one other fungicide. Mixing components which are particularly suited for this purpose include e.g. azoles, such as azaconazole, BAY 14120, bitertanol, bromuconazole, cyproconazole, difenoconazole, diniconazole, epoxiconazole, fenbuconazole, fluquinconazole, flusilazole, flutriafol, hexaconazole, imazalil, imibenconazole, ipconazole, metconazole, myclobutanil, pefurazoate, penconazole, pyrifenox, prochloraz, propiconazole, simeconazole, tebuconazole, tetraconazole, triadimefon, triadimenol, triflumizole, triticonazole; pyrimidinyl carbinoles, such as ancymidol, fenarimol, nuarimol; 2-amino-pyrimidines, such as bupirimate, dimethirimol, ethirimol; morpholines, such as dodemorph, fenpropidine, fenpropimorph, spiroxamine, tridemorph; anilinopyrimidines, such as cyprodinil, mepanipyrim, pyrimethanil; pyrroles, such as fenpiclonil, fludioxonil; phenylamides, such as benalaxyl, furalaxyl, metalaxyl, R-metalaxyl, ofurace, oxadixyl; benzimidazoles, such as benomyl, carbendazim, debacarb, fuberidazole, thiabendazole; dicarboximides, such as chlozolinate, dichlozoline, iprodione, myclozoline, procymidone, vinclozoline; carboxamides, such as carboxin, fenfuram, flutolanil, mepronil, oxycarboxin, thifluzamide; guanidines, such as guazatine, dodine, iminoctadine; strobilurines, such as azoxystrobin, kresoxim-methyl, metominostrobin, SSF-129, trifloxystrobin, picoxystrobin, BAS 500F (proposed name pyraclostrobin), BAS 520; dithiocarbamates, such as ferbam, mancozeb, maneb, metiram, propineb, thiram, zineb, ziram; N-halomethylthiotetrahydrophthalimides, such as captafol, captan, dichlofluanid, fluoromides, folpet, tolyfluanid; Cu-compounds, such as Bordeaux mixture, copper hydroxide, copper oxychloride, copper sulfate, cuprous oxide, mancopper, oxine-copper; nitrophenol-derivatives, such as dinocap, nitrothal-isopropyl; organo-p-derivatives, such as edifenphos, iprobenphos, isoprothiolane, phosdiphen, pyrazophos, tolciofos-methyl; various others, such as acibenzolar-S-methyl, anilazine, benthiavalicarb, blasticidin-S, chinomethionate, chloroneb, chlorothalonil, cyflufenamid, cymoxanil, dichione, diclomezine, dicloran, diethofencarb, dimethomorph, SYP-LI90 (proposed name: flumorph), dithianon, ethaboxam, etridiazole, famoxadone, fenamidone, fenoxanil, fentin, ferimzone, fluazinam, flusulfamide, fenhexamid, fosetyl-aluminium, hymexazol, iprovalicarb, IKF-916 (cyazofamid), kasugamycin, methasulfocarb, metrafenone, nicobifen (new proposal: boscalid), pencycuron, phthalide, polyoxins, probenazole, propamocarb, pyroquilon, quinoxyfen, quintozene, sulfur, triazoxide, tricyclazole, triforine, validamycin, zoxamide (RH7281).

Some particularly interesting mixtures in view of technical value in the agricultural practice (comprising at least the one mentioned compound of formula I together with the above mentioned mentioned other fungicide, but not being limited thereto, i.e. such mixtures may comprise additional components according to needs when controlling certain fungi on certain crop plants), having enhanced synergistic levels of fungicidal activity, or being especially well suited for the control of persistent or very damaging phytopathogenic fungi are among the following:
1) (S)-2-phenyl-N-[2-(3-methoxy-4-prop-2-ynyloxy-phenyl)-ethyl]-2-prop-2-ynyloxy-acetamide (compound E1.002), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-Al, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide; and
2) (S)-2-(4-chloro-phenyl)-N-[2-(3-methoxy-4-prop-2-ynyloxy-phenyl)-ethyl]-2-prop-2-ynyloxy-acetamide (compound E1.011), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-Al, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy) -phenyl}-ethyl]-amide, and
3) (S)-2-(4-bromo-phenyl)-N-[2-(3-methoxy-4-prop-2-ynyloxy-phenyl)-ethyl]-2-prop-2-ynyloxy-acetamide (compound E1.022), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsul-fonyl-amino)-3-methyl-butyric acid N-[2-{3-methoxy-4-(3-(4-chlorophenyl)-2-propyn-1-yloxy)-phenyl}-ethyl]-amide, and
4) (S)-2-(4-fluoro-phenyl)-N-[2-(3-methoxy-4-prop-2-ynyloxy-phenyl)-ethyl]-2-prop-2-ynyloxy-acetamide (compound E1.033), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsul-fonyl-amino) -3-methyl-butyric acid N-[2-{3-methoxy-4-(3-(4-chlorophenyl)-2-propyn-1-yloxy) -phenyl}-ethyl]-amide, and
5) (S)-2-(4-tolyl)-N-[2-(3-methoxy-4-prop-2-ynyloxy-phenyl)-ethyl]-2-prop-2-ynyloxy-acetamide (compound E1.045), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-(3-methoxy-4-(3-(4-chlorophenyl)-2-propyn-1-yloxy)-phenyl)-ethyl]-amide, and
6) (S)-2-(4-ethyl-phenyl)-N-[2-(3-methoxy-4-prop-2-ynyloxy-phenyl)-ethyl]-2-prop-2-ynyloxy-acetamide (compound E1.053), combined with any one active ingredient selected from cymoxanil, trifloxystrobin, azoxystrobin, picoxystrobin, chlorothalonil, metalaxyl, metala-xyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide, and
7) (S)-2-(3,4-difluoro-phenyl)-N-[2-(3-methoxy-4-prop-2-ynyloxy-phenyl)-ethyl]-2-prop-2-ynyloxy-acetamide (compound E1.085), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide, and
8) (S)-2-(3-fluoro-4-chloro-phenyl)-N-[2-(3-methoxy-4-prop-2-ynyloxy-phenyl)-ethyl]-2-prop-2-ynyloxy-acetamide (compound E1.091), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide, and
9) (S)-2-(3,4-dichloro-phenyl)-N-[2-(3-methoxy-4-prop-2-ynyloxy-phenyl)-ethyl]-2-prop-2-ynyloxy-acetamide (compound E1.102), combined with any one active ingredient selected from cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide.

In the above mentioned mixtures, the mixture ratio of the active ingredients is so selected that it reaches optional control of the phytopathogenic microorganism on the host plants. This ratio is in general between 100:1 and 1:100, preferably between 50:1 and 1:100, more preferably between 10:1 and 1:10, most preferably between 5:1 and 1:10 of a compound of formula I vis-à-vis the second fungicide. The mixtures may not only comprise one of the listed combinational active ingredients, but may comprise more than one additional active ingredients selected from that specified group, thus forming for example 3-way- or even 4-way-mixtures.

Suitable carriers and surfactants may be solid or liquid and correspond to the substances ordinarily employed in formulation technology, such as e.g. natural or regenerated mineral substances, solvents, dispersants, wetting agents, tackifiers, thickeners, binders or fertilisers. Such carriers and additives are described, for example, in WO 95/30651.

A preferred method of applying a compound of formula I, or an agrochemical composition comprising at least one of those compounds, is application to the foliage (foliar application), the frequency and the rate of application depending upon the risk of infestation by the pathogen in question. The compounds of formula I may also be applied to seed grains (coating) either by impregnating the grains with a liquid formulation of the active ingredient or by coating them with a solid formulation.

The compounds of formula I are used in unmodified form or, preferably, together with the adjuvants conventionally employed in formulation technology, and are for that purpose advantageously formulated in known manner e.g. into emulsifiable concentrates, coatable pastes, directly sprayable or dilutable solutions, dilute emulsions, wettable powders, soluble powders, dusts, granules, and by encapsulation in e.g. polymer substances. As with the nature of the compositions, the methods of application, such as spraying, atomising, dusting, scattering, coating or pouring, are chosen in accordance with the intended objectives and the prevailing circumstances.

Advantageous rates of application are normally from 1 g to 2 kg of active ingredient (a.i.) per hectare (ha), preferably from 5 g to 1 kg a.i./ha, preferably from 25 g to 750 g a.i./ha, especially from 10 g to 500 g a.i./ha, more preferably from 5 g to 500 g a.i./ha. Most preferred is 5 g to 250 g a.i./ha . When used as seed dressings, rates of from 0.001 g to 1.0 g of active ingredient per kg of seed are advantageously used.

The formulations, i.e. the compositions, preparations or mixtures comprising the compound(s) (active ingredient(s)) of formula I and, where appropriate, a solid or liquid adjuvant, are prepared in known manner, e.g. by homogeneously mixing and/or grinding the active ingredient with extenders, e.g. solvents, solid carriers and, where appropriate, surface-active compounds (surfactants).

Further surfactants customarily used in formulation technology will be known to the person skilled in the art or can be found in the relevant technical literature.

The agrochemical compositions usually comprise 0.01 to 99% by weight, preferably 0.1 to 95% by weight, of a compound of formula I, 99.99 to 1% by weight, preferably 99.9 to 5% by weight, of a solid or liquid adjuvant, and 0 to 25% by weight, preferably 0.1 to 25% by weight, of a surfactant.

Whereas commercial products will preferably be formulated as concentrates, the end user will normally employ dilute formulations.

The compositions may also comprise further ingredients, such as stabilisers, antifoams, viscosity regulators, binders and tackifiers, as well as fertilisers or other active ingredients for obtaining special effects.

The Examples which follow illustrate the invention described above, without limiting the scope thereof in any way. Temperatures are given in degrees Celsius. Ph stands for phenyl.

### PREPARATION EXAMPLES

### Example E1

### (S)-N-[2-(3-Methoxy-4-prop-2-ynyloxy-phenyl)-ethyl]-2-phenyl-2-prop-2-ynyloxy-acetamide

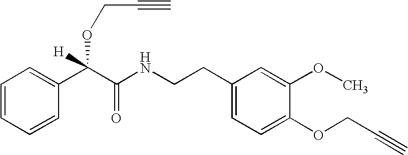

### a) (S)-2-Hydroxy-N-[2-(3-methoxy-4-prop-2-ynyloxy-phenyl)-ethyl]-2-phenyl-acetamide

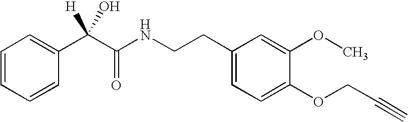 2-(3-Methoxy-4-prop-2-ynyloxy-phenyl)-ethylamine hydrochloride (8.5 g, 35 mol) and N,N-di-isopropylethylamine (17 g, 0.13 mol) are dissolved in 100 ml of N,N-dimethylformamide. To this solution L-(+)-mandelic acid [(S)-α-hydroxyphenylacetic acid] (5.0 g, 33 mmol) and (benzotriazol-1-yloxy)-tris-(dimethylamino)-phosphonium hexafluorophosphate (16 g, 36 mmol) are added successively. The reaction mixture is stirred for 3 h at room temperature subsequently poured on ice-water and extracted several times with ethyl acetate. The combined organic layer is washed with brine, dried over sodium sulfate and evaporated in vacuo. The remaining oil is purified by chromatography on silicagel (ethyl acetate/hexane 1:1) to yield (S)-2-hydroxy-N-[2-(3-methoxy-4-prop-2-ynyloxy-phenyl)-ethyl]-2-phenyl-acetamide

¹H-NMR (300 MHz, CDCl₃): 2.72 (t, 1 H, C≡CH), 2.93 (q, 2H, CH₂CH₂), 3.72 (dt, 2H, CH₂CH₂), 4.01 (s, 3H, OCH₃), 4.97 (d, 2H, OCH₂), 5.20 (s, 1H, CHOH), 6.28 (bs, 1H, NH), 6.73-7.58 (m, 8H, CH arom.).
b) A 80% solution of propargyl bromide in toluene (4.5 g, 30 mmol) is added slowly at room temperature to a mixture of (S)-2-hydroxy-N-[2-(3-methoxy-4-prop-2-ynyloxy-phenyl)-ethyl]-2-phenyl-acetamide (8.0 g, 24 mmol), 30% sodium hydroxide solution (12 ml, 118 mmol) and catalytic amounts of tetrabutylammonium bromide (75 mg) in 40 ml of dichloromethane. The reaction is stirred for 16 hours at +40° C. Subsequently the mixture is evaporated and the residue is diluted with water and dichloromethane. The phases are separated and the aqueous phase is extracted three times with dichloromethane. The combined organic layer is washed with brine, dried over sodium sulfate and evaporated. The remaining oil is purified by chromatography on silica gel (ethyl acetate/hexane 1:1) to give (S)-N-[2-(3-methoxy-4-prop-2-ynyloxy-phenyl)-ethyl]-2-phenyl-2-prop-2-ynyloxy-acetamide.

¹H-NMR (300 MHz, CDCl₃): 2.41 (t, 1H, C≡CH), 2.46 (t, 1H, C≡CH), 2.73 (t, 2H, CH₂CH₂), 3.48 (m, 2H, CH₂CH₂), 3.79 (s, 3H, OCH₃), 3.91 (dd, 1H, OCH₂), 4.12 (dd, 1H, OCH₂), 4.71 (d, 2H, OCH₂), 4.93 (s, 1H, CHO), 6.62-7.30 (m, 9H, CH arom., NH). M.p.: 81-83° C.

According to the procedures of Example E1 the compounds listed in table E1 are obtained.

TABLE E1

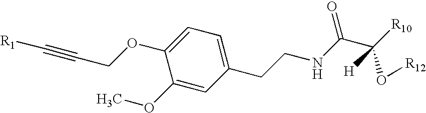

| | | | | ¹H-NMR (300 MHz, |
|---|---|---|---|---|
| No. | R₁ | R₁₀ | R₁₂ | CDCl₃): δ = |
| E1.001 | H | Ph | CH₂CH₃ | |
| E1.002 | H | Ph | CH₂C≡CH | 2.41 (t, 1H), 2.46 (t, 1H), 2.73 |
| | | | | (t, 2H), 3.48 (m, 2H), 3.79 (s, |
| | | | | 3H), 3.91 (dd, 1H), 4.12 (dd, |
| | | | | 1H), 4.71 (d, 2H), 4.93 (s, |
| | | | | 1H), 6.62-7.30 (m, 8H) |
| E1.003 | H | 4-Cl-Ph | CH₃ | |
| E1.004 | H | 4-Cl-Ph | CH₂CH₃ | |
| E1.005 | H | 4-Cl-Ph | CH₂CF₃ | |
| E1.006 | H | 4-Cl-Ph | n-C₃H₇ | |
| E1.007 | H | 4-Cl-Ph | i-C₃H₇ | |
| E1.008 | H | 4-Cl-Ph | CH₂-cycl-C₃H₅ | |
| E1.009 | H | 4-Cl-Ph | CH₂CH═CH₂ | |
| E1.010 | H | 4-Cl-Ph | CH₂C(CH₃)═CH₂ | |
| E1.011 | H | 4-Cl-Ph | CH₂C≡CH | 2.42 (t, 1H), 2.47 (t, 1H), 2.74 |
| | | | | (t, 2H), 3.50 (t, 2H), 3.79 (s, |
| | | | | 3H), 3.91 (dd, 1H), 4.14 (dd, |
| | | | | 1H), 4.69 (d, 2H), 4.91 (s, |
| | | | | 1H), 6.62-7.29 (m, 7H) |
| E1.012 | CH₂CH₃ | 4-Cl-Ph | CH₂C≡CH | |
| E1.013 | 4-Cl-Ph | 4-Cl-Ph | CH₂C≡CH | |
| E1.014 | H | 4-Cl-Ph | CH₂C≡CCH₃ | |
| E1.015 | H | 4-Cl-Ph | CH₂C≡CCH₂CH₃ | |
| E1.016 | H | 4-Cl-Ph | CH₂C≡C-cycl-C₃H₅ | |
| E1.017 | H | 4-Cl-Ph | C(CH₃)₂C≡CH | |
| E1.018 | H | 4-Cl-Ph | CH₂OCH₂CH₃ | |
| E1.019 | H | 4-Br-Ph | CH₃ | |
| E1.020 | H | 4-Br-Ph | CH₂CH₃ | |
| E1.021 | H | 4-Br-Ph | CH₂CH═CH₂ | |
| E1.022 | H | 4-Br-Ph | CH₂C≡CH | |
| E1.023 | CH₂CH₃ | 4-Br-Ph | CH₂C≡CH | |
| E1.024 | 4-Cl-Ph | 4-Br-Ph | CH₂C≡CH | |
| E1.025 | H | 4-Br-Ph | CH₂C≡CCH₃ | |
| E1.026 | H | 4-Br-Ph | CH₂C≡CCH₂CH₃ | |
| E1.027 | H | 4-Br-Ph | CH₂C≡C-cycl-C₃H₅ | |
| E1.028 | H | 4-Br-Ph | CH₂Ph | |
| E1.029 | H | 3-F-Ph | CH₂CH₃ | |
| E1.030 | H | 3-F-Ph | CH₂C≡CH | |
| E1.031 | H | 4-F-Ph | CH₃ | |
| E1.032 | H | 4-F-Ph | CH₂CH₃ | |
| E1.033 | H | 4-F-Ph | CH₂C≡CH | |
| E1.034 | H | 2-Cl-Ph | CH₃ | |
| E1.035 | H | 2-Cl-Ph | CH₂CH₃ | |
| E1.036 | H | 2-Cl-Ph | CH₂C≡CH | |
| E1.037 | H | 3-Cl-Ph | CH₂CH₃ | |
| E1.038 | H | 3-Cl-Ph | CH₂C≡CH | |
| E1.039 | H | 3-Br-Ph | CH₂CH₃ | |
| E1.040 | H | 3-Br-Ph | CH₂C≡CH | |
| E1.041 | H | 3-H₃C-Ph | CH₂CH₃ | |
| E1.042 | H | 3-H₃C-Ph | CH₂C≡CH | |
| E1.043 | H | 4-H₃C-Ph | CH₃ | |
| E1.044 | H | 4-H₃C-Ph | CH₂CH₃ | |
| E1.045 | H | 4-H₃C-Ph | CH₂C≡CH | |
| E1.046 | H | 3-F₃C-Ph | CH₂CH₃ | |
| E1.047 | H | 3-F₃C-Ph | CH₂C≡CH | |
| E1.048 | H | 4-F₃C-Ph | CH₃ | |
| E1.049 | H | 4-F₃C-Ph | CH₂CH₃ | |
| E1.050 | H | 4-F₃C-Ph | CH₂C≡CH | |
| E1.051 | H | 4-C₂H₅-Ph | CH₃ | |
| E1.052 | H | 4-C₂H₅-Ph | CH₂CH₃ | |
| E1.053 | H | 4-C₂H₅-Ph | CH₂C≡CH | |
| E1.054 | H | 4-CH₂═CH-Ph | CH₂CH₃ | |
| E1.055 | H | 4-CH₂═CH-Ph | CH₂C≡CH | |
| E1.056 | H | 4-HC≡C-Ph | CH₂CH₃ | |
| E1.057 | H | 4-HC≡C-Ph | CH₂C≡OH | |
| E1.058 | H | 3-N≡C-Ph | CH₂CH₃ | |
| E1.059 | H | 3-N≡C-Ph | CH₂C≡OH | |
| E1.060 | H | 4-N≡C-Ph | CH₂CH₃ | |
| E1.061 | H | 4-N≡C-Ph | CH₂C≡CH | |
| E1.062 | H | 4-n-C₃H₇-Ph | CH₃ | |
| E1.063 | H | 4-n-C₃H₇-Ph | CH₂CH₃ | |
| E1.064 | H | 4-n-C₃H₇-Ph | CH₂C≡CH | |
| E1.065 | H | 4-i-C₃H₇-Ph | CH₂CH₃ | |
| E1.066 | H | 4-i-C₃H₇-Ph | CH₂C≡CH | |
| E1.067 | H | 4-t-C₄H₉-Ph | CH₂CH₃ | |
| E1.068 | H | 4-t-C₄H₉-Ph | CH₂C≡CH | |
| E1.069 | H | 4-H₃CO₂C-Ph | CH₂C≡CH | |
| E1.070 | H | 4-H₃CS-Ph | CH₂CH₃ | |
| E1.071 | H | 4-H₃CS-Ph | CH₂C≡CH | |
| E1.072 | H | 4-H₃CO-Ph | CH₂CH₃ | |
| E1.073 | H | 4-H₃CO-Ph | CH₂C≡CH | |
| E1.074 | H | 3-F₃CO-Ph | CH₂CH₃ | |
| E1.075 | H | 3-F₃CO-Ph | CH₂C≡CH | |
| E1.076 | H | 4-F₃CO-Ph | CH₂CH₃ | |
| E1.077 | H | 4-F₃CO-Ph | CH₂C≡CH | |
| E1.078 | H | 4-C₂H₅O-Ph | CH₂CH₃ | |
| E1.079 | H | 4-C₂H₅O-Ph | CH₂C≡CH | |
| E1.080 | H | 4-(HC≡OCH₂O)-Ph | CH₂C≡CH | |
| E1.081 | H | 4-PhO-Ph | CH₂CH₃ | |
| E1.082 | H | 4-PhO-Ph | CH₂C≡CH | |
| E1.083 | H | 3,4-F₂-Ph | CH₃ | |
| E1.084 | H | 3,4-F₂-Ph | CH₂CH₃ | |
| E1.085 | H | 3,4-F₂-Ph | CH₂C≡CH | |
| E1.086 | H | 3,5-F₂-Ph | CH₂CH₃ | |
| E1.087 | H | 3,5-F₂-Ph | CH₂C≡CH | |
| E1.088 | H | 3-Cl-4-F-Ph | CH₃ | |
| E1.089 | H | 3-Cl-4-F-Ph | CH₂CH₃ | |
| E1.090 | H | 3-Cl-4-F-Ph | CH₂C≡CH | |
| E1.091 | H | 4-Cl-3-F-Ph | CH₂C≡CH | |
| E1.092 | H | 3-F-4-H₃CO-Ph | CH₂CH₃ | |
| E1.093 | H | 3-F-4-H₃CO-Ph | CH₂C≡CH | |
| E1.094 | H | 3-Br-4-F-Ph | CH₂CH₃ | |
| E1.095 | H | 3-Br-4-F-Ph | CH₂C≡CH | |
| E1.096 | H | 4-Br-2-F-Ph | CH₂CH₃ | |
| E1.097 | H | 4-Br-2-F-Ph | CH₂C≡CH | |
| E1.098 | H | 2,4-Cl₂-Ph | CH₂CH₃ | |
| E1.099 | H | 2,4-Cl₂-Ph | CH₂C≡CH | |
| E1.100 | H | 3,4-Cl₂-Ph | CH₃ | |
| E1.101 | H | 3,4-Cl₂-Ph | CH₂CH₃ | |
| E1.102 | H | 3,4-Cl₂-Ph | CH₂C≡CH | |
| E1.103 | H | 3,5-Cl₂-Ph | CH₂CH₃ | |
| E1.104 | H | 3,5-Cl₂-Ph | CH₂C≡CH | |
| E1.105 | H | 3-Cl-4-H₃C-Ph | CH₂CH₃ | |
| E1.106 | H | 3-Cl-4-H₃C-Ph | CH₂C≡CH | |
| E1.107 | H | 4-Cl-3-F₃C-Ph | CH₂CH₃ | |
| E1.108 | H | 4-Cl-3-F₃C-Ph | CH₂C≡CH | |
| E1.109 | H | 3,4-Br₂-Ph | CH₂CH₃ | |
| E1.110 | H | 3,4-Br₂-Ph | CH₂C≡CH | |
| E1.111 | H | 3,4-(H₃C)₂-Ph | CH₂CH₃ | |
| E1.112 | H | 3,4-(H₃C)₂-Ph | CH₂C≡CH | |
| E1.113 | H | 3,5-(H₃C)₂-Ph | CH₂CH₃ | |
| E1.114 | H | 3,5-(H₃C)₂-Ph | CH₂C≡CH | |
| E1.115 | H | 3-H₃C-4-H₃CO-Ph | CH₂CH₃ | |
| E1.116 | H | 3-H₃C-4-H₃CO-Ph | CH₂C≡CH | |
| E1.117 | H | 3,4-(H₃CO)₂-Ph | CH₂CH₃ | |
| E1.118 | H | 3,4-(H₃CO)₂-Ph | CH₂C≡CH | |
| E1.119 | H | 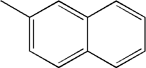 | CH₃ | |
| E1.120 | H | 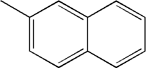 | CH₂CH₃ | |
| E1.121 | H | 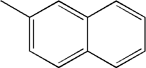 | CH₂C≡CH | |
| E1.122 | H | 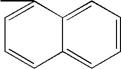 | CH₂CH₃ | |
| E1.123 | H | 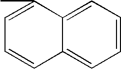 | CH₂C≡CH | |
| E1.124 | H | 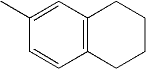 | CH₂CH₃ | |
| E1.125 | H | 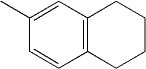 | CH₂C≡CH | |
| E1.126 | H | 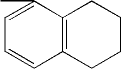 | CH₂CH₃ | |
| E1.127 | H | 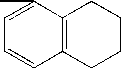 | CH₂C≡CH | |
| E1.128 | H | 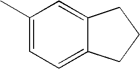 | CH₂CH₃ | |
| E1.129 | H | 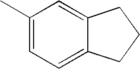 | CH₂C≡CH | |
| E1.130 | H | 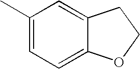 | CH₂CH₃ | |
| E1.131 | H | 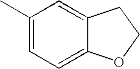 | CH₂C≡CH | |
| E1.132 | H | 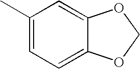 | CH₂CH₃ | |
| E1.133 | H | 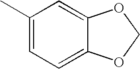 | CH₂C≡CH | |
| E1.134 | H | 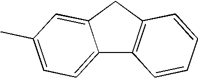 | CH₂CH₃ | |
| E1.135 | H | 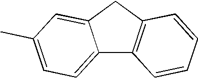 | CH₂C≡CH | |
| E1.136 | H | 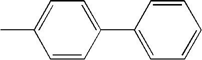 | CH₃ | |
| E1.137 | H | 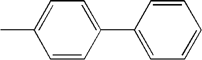 | CH₂CH₃ | |
| E1.138 | H | 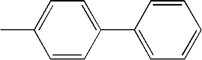 | CH₂C≡CH | |
| E1.139 | H | 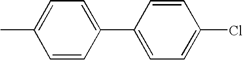 | CH₂C≡CH | |
| E1.140 | H | 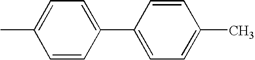 | CH₂C≡CH | |
| E1.141 | H | 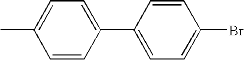 | CH₂C≡CH | |
| E1.142 | H | 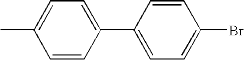 | CH₂CH═CH₂ | |
| E1.143 | H | 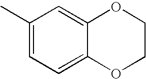 | CH₂CH₃ | |
| E1.144 | H | 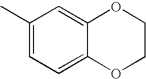 | CH₂C≡CH | |
| E1.145 | H | 3-H₃CO-Ph | CH₂CH₃ | |
| E1.146 | H | 3-H₃CO-Ph | CH₂C≡CH | |
| E1.147 | H | 2,3,5-Cl₃-Ph | CH₂CH₃ | |
| E1.148 | H | 2,3,5-Cl₃-Ph | CH₂C≡CH | |
| E1.149 | H | 2,3-Cl₂-Ph | CH₂CH₃ | |
| E1.150 | H | 2,3-Cl₂-Ph | CH₂C≡CH | |
| E1.151 | CH₂CH₃ | Ph | CH₂CH₃ | 1.11-1.23(m, 6H), 2.23(q, |
| | | | | H), 2.81 (t, 2H), 3.42-3.57 |
| | | | | (m, 4H), 3.86 (s, 3H), 4.70- |
| | | | | 4.77 (m, 3H), 6.69-7.40 (m, |
| | | | | 8H) |
| E1.152 | CH₂CH₃ | Ph | CH₂C≡CH | 1.13 (t, 3H), 2.22 (q, 2H), 2.48 |
| | | | | (t, 1H), 2.80 (1, 2H), 3.57 (q, |
| | | | | 2H), 3.84 (s, 3H), 3.99 (dd, |
| | | | | 1H), 4.19 (dd, 1H), 4.73 (d, |
| | | | | 2H), 5.02 (s, 1H), 6.70-7.39 |
| | | | | (m, 8H) |

(Ph designates phenyl), the asymmetrical carbon is in (S)-form

Analogously to the above examples the (S)-form of compounds of tables 1 to 31 are obtained.

TABLE 1
Compounds represented by the Formula I.01

(I.01)

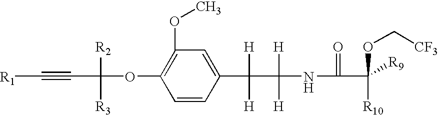

wherein the combination of the groups R₁, R₂, R₃, R₉ and R₁₀ corresponds each to one row in table A.

TABLE 2
Compounds represented by the Formula I.02

(I.02)

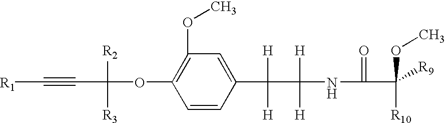

wherein the combination of the groups R₁, R₂, R₃, R₉ and R₁₀ corresponds each to one row in table A.

TABLE 3
Compounds represented by the Formula I.03

(I.03)

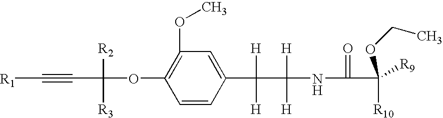

wherein the combination of the groups R₁, R₂, R₃, R₉ and R₁₀ corresponds each to one row in table A.

TABLE 4
Compounds represented by the Formula I.04

(I.04)

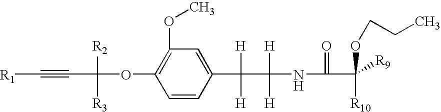

wherein the combination of the groups R₁, R₂, R₃, R₉ and R₁₀ corresponds each to one row in table A.

TABLE 5
Compounds represented by the Formula I.05

(I.05)

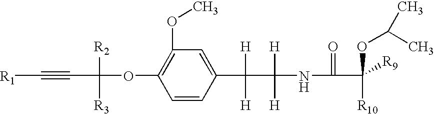

wherein the combination of the groups R₁, R₂, R₃, R₉ and R₁₀ corresponds to each one row in table A.

TABLE 6
Compounds represented by the Formula I.06

(I.06)

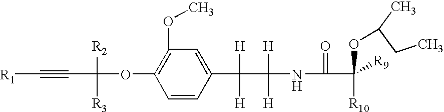

wherein the combination of the groups R₁, R₂, R₃, R₉ and R₁₀ corresponds each to one row in table A.

TABLE 7
Compounds represented by the Formula I.07

(I.07)

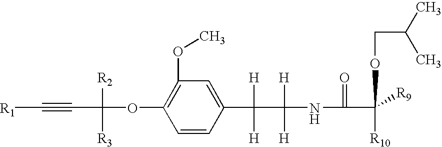

wherein the combination of the groups R₁, R₂, R₃, R₉ and R₁₀ corresponds each to one row in table A.

TABLE 8
Compounds represented by the Formula I.08

(I.08)

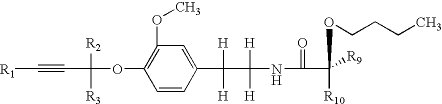

wherein the combination of the groups R₁, R₂, R₃, R₉ and R₁₀ corresponds each to one row in table A.

TABLE 9
Compounds represented by the Formula I.09

(I.09)

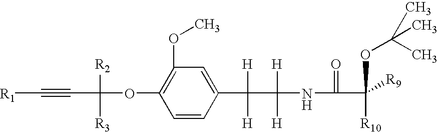

wherein the combination of the groups R₁, R₂, R₃, R₉ and R₁₀ corresponds each to one row in table A

TABLE 10
Compounds represented by the Formula I.10

| | |
|---|---|
| | (I.10) |
| 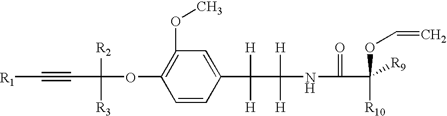 | |

wherein the combination of the groups R₁, R₂, R₃, R₉ and R₁₀ corresponds each to one row in table A.

TABLE 11
Compounds represented by the Formula I.11

| | |
|---|---|
| | (I.11) |
| 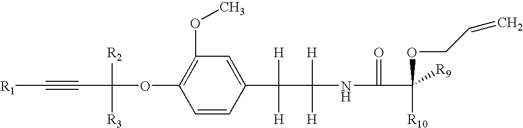 | |

wherein the combination of the groups R₁, R₂, R₃, R₉ and R₁₀ corresponds each to one row in table A.

TABLE 12
Compounds represented by the I.12

| | |
|---|---|
| | (I.12) |
| 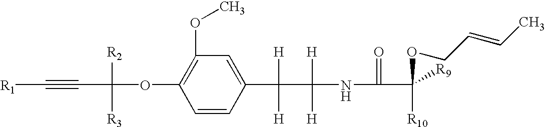 | |

wherein the combination of the groups R₁, R₂, R₃, R₉ and R₁₀ corresponds each to one row in table A.

TABLE 13
Compounds represented by the Formula I.13

| | |
|---|---|
| | (I.13) |
| 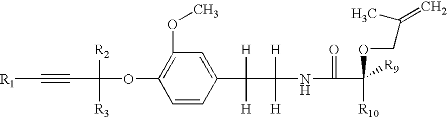 | |

wherein the combination of the groups R₁, R₂, R₃, R₉ and R₁₀ corresponds each to one row in table A.

TABLE 14
Compounds represented by the Formula I.14

| | |
|---|---|
| | (I.14) |
| 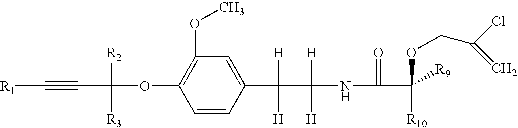 | |

wherein the combination of the groups R₁, R₂, R₃, R₉ and R₁₀ corresponds each to one row in table A.

TABLE 15
Compounds represented by the Formula I.15

| | |
|---|---|
| | (I.15) |
| 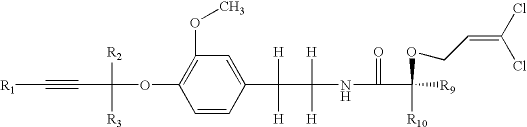 | |

wherein the combination of the groups R₁, R₂, R₃, R₉ and R₁₀ corresponds each to one row in table A.

TABLE 16
Compounds represented by the Formula I.16

| | |
|---|---|
| | (I.16) |
| 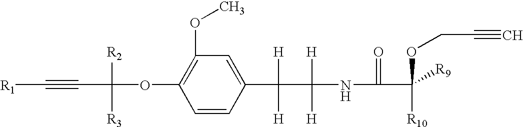 | |

wherein the combination of the groups R₁, R₂, R₃, R₉ and R₁₀ corresponds each to one row in table A.

TABLE 17
Compounds represented by the Formula I.17

| | |
|---|---|
| | (I.17) |
| 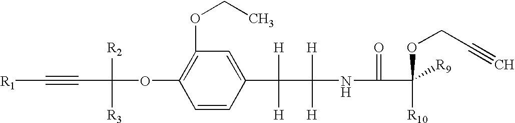 | |

wherein the combination of the groups R₁, R₂, R₃, R₉ and R₁₀ corresponds each to one row in table A.

TABLE 18
Compounds represented by the Formula I.18

| | |
|---|---|
| | (I.18) |
| 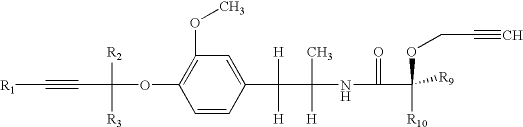 | |

wherein the combination of the groups R₁, R₂, R₃, R₉ and R₁₀ corresponds each to one row in table A.

TABLE 19
Compounds represented by the Formula I.19

| | |
|---|---|
| | (I.19) |
| 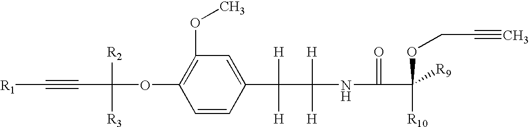 | |

wherein the combination of the groups R₁, R₂, R₃, R₉ and R₁₀ corresponds each to one row in table A.

TABLE 20
Compounds represented by the Formula I.20

(I.20)

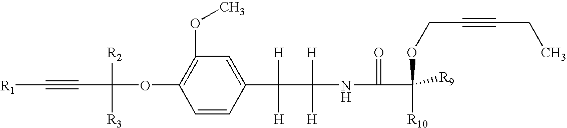

wherein the combination of the groups R₁, R₂, R₃, R₉ and R₁₀ corresponds each to one row in table A.

TABLE 21
Compounds represented by the Formula I.21

(I.21)

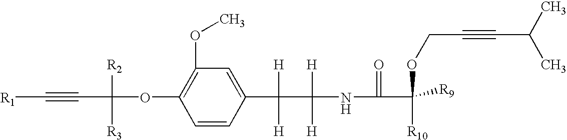

wherein the combination of the groups R₁, R₂, R₃, R₉ and R₁₀ corresponds each to one row in table A.

TABLE 22
Compounds represented by the Formula I.22

(I.22)

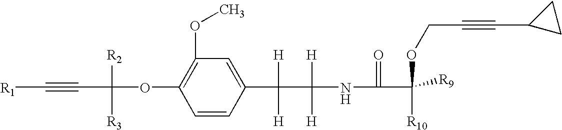

wherein the combination of the groups R₁, R₂, R₃, R₉ and R₁₀ corresponds each to one row in table A.

TABLE 23
Compounds represented by the Formula I.23

(I.23)

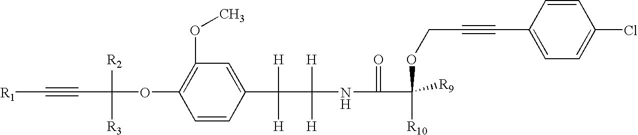

wherein the combination of the groups R₁, R₂, R₃, R₉ and R₁₀ corresponds each to one row in table A.

TABLE 24
Compounds represented by the Formula I.24

(I.24)

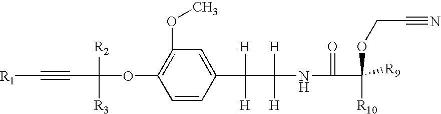

wherein the combination of the groups R₁, R₂, R₃, R₉ and R₁₀ corresponds each to one row in table A.

TABLE 25
Compounds represented by the Formula I.25

(I.25)

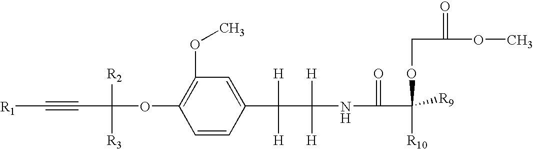

wherein the combination of the groups R₁, R₂, R₃, R₉ and R₁₀ corresponds each to one row in table A.

TABLE 26
Compounds represented by the Formula I.26

(I.26)

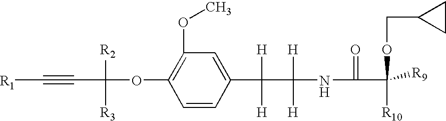

wherein the combination of the groups R₁, R₂, R₃, R₉ and R₁₀ corresponds each to one row in table A.

TABLE 27
Compounds represented by the Formula I.27

(I.27)

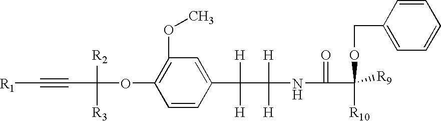

wherein the combination of the groups R₁, R₂, R₃, R₉ and R₁₀ corresponds each to one row in table A.

TABLE 28
Compounds represented by the Formula I.28

(I.28)

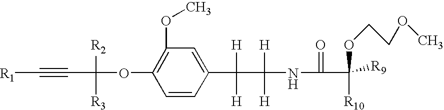

wherein the combination of the groups R₁, R₂, R₃, R₉ and R₁₀ corresponds each to one row in table A.

TABLE 29
Compounds represented by the Formula I.29

(I.29)

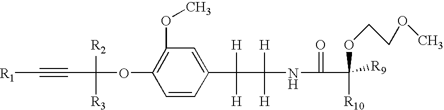

wherein the combination of the groups R₁, R₂, R₃, R₉ and R₁₀ corresponds each to one row in table A.

TABLE 30
Compounds represented by the Formula I.30

(I.30)

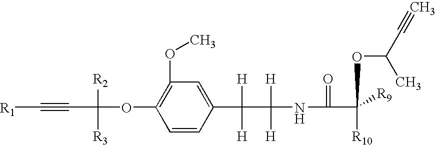

wherein the combination of the groups R₁, R₂, R₃, R₉ and R₁₀ corresponds each to one row in table A.

TABLE 31
Compounds represented by the Formula I.31

(I.31)

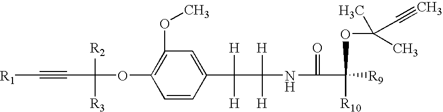

wherein the combination of the groups R₁, R₂, R₃, R₉ and R₁₀ corresponds each to one row in table A.

TABLE A

| No. | R₁ | R₂ | R₃ | R₉ | R₁₀ |
|---|---|---|---|---|---|
| 001 | H | H | H | H | Ph |
| 002 | H | H | H | H | 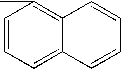 |
| 003 | H | H | H | H | 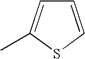 |
| 004 | H | H | H | H | 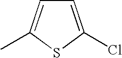 |
| 005 | H | H | H | H | 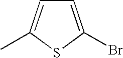 |
| 006 | H | H | H | H | 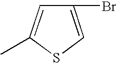 |
| 007 | H | H | H | H | 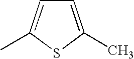 |
| 008 | H | H | H | H | 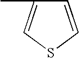 |
| 009 | H | H | H | H | 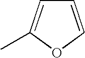 |
| 010 | H | H | H | H | 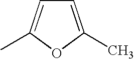 |
| 011 | H | H | H | H | 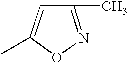 |
| 012 | H | H | H | H | 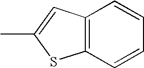 |
| 013 | H | H | H | H | 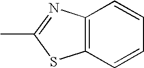 |
| 014 | H | H | H | H | 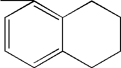 |
| 015 | H | H | H | H | 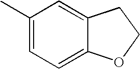 |
| 016 | H | H | H | H | 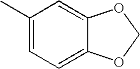 |
| 017 | H | H | H | H | 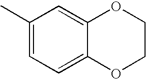 |
| 018 | H | H | H | H | 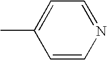 |
| 019 | H | H | H | H | 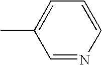 |
| 020 | H | H | H | H | 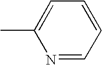 |
| 021 | H | H | H | H | 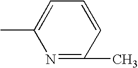 |
| 022 | H | H | H | H | 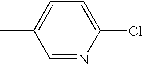 |
| 023 | H | H | H | H | 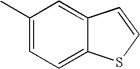 |
| 024 | H | H | H | H | 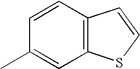 |
| 025 | H | H | H | H | 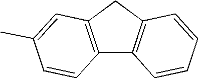 |
| 026 | H | H | H | H | 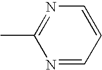 |
| 027 | H | H | H | H | 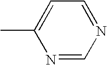 |
| 028 | H | H | H | H | 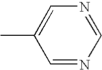 |
| 029 | H | H | H | H | 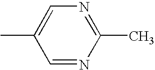 |
| 030 | H | H | H | H | 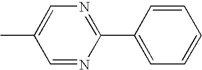 |
| 031 | H | H | H | H | 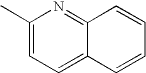 |
| 032 | H | H | H | H | 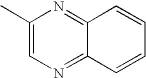 |
| 033 | H | H | H | H | 2-CH₃-Ph |
| 034 | H | H | H | H | 3-CH₃-Ph |
| 035 | H | H | H | H | 3-CF₃-Ph |
| 036 | H | H | H | H | 2-F-Ph |
| 037 | H | H | H | H | 3-F-Ph |
| 038 | H | H | H | H | 4-H₂C═CH-Ph |
| 039 | H | H | H | H | 4-HC≡C-Ph |
| 040 | H | H | H | H | 4-CH₃—CH₂—CH₂-Ph |
| 041 | H | H | H | H | 4-(CH₃)₂CH-Ph |
| 042 | H | H | H | H | 4-(CH₃)₃C-Ph |
| 043 | H | H | H | H | 4-CH₃—CH₂O-Ph |
| 044 | H | H | H | H | 4-PhO-Ph |
| 045 | H | H | H | H | 4-PhCH₂O-Ph |
| 046 | H | H | H | H | 4-HC≡CCH₂O-Ph |
| 047 | H | H | H | H | 3-CH₃O-Ph |
| 048 | H | H | H | H | 4-CH₃O-Ph |
| 049 | H | H | H | H | 3-CF₃O-Ph |
| 050 | H | H | H | H | 4-CH₃S-Ph |
| 051 | H | H | H | H | 4-CF₃S-Ph |
| 052 | H | H | H | H | 4-CH₃SO₂-Ph |
| 053 | H | H | H | H | 3-CN-Ph |
| 054 | H | H | H | H | 4-CN-Ph |
| 055 | H | H | H | H | 4-NO₂-Ph |
| 056 | H | H | H | H | 4-CH₃O₂C-Ph |
| 057 | H | H | H | H | 3-I-Ph |
| 058 | H | H | H | H | 4-I-Ph |
| 059 | H | H | H | H | 2-Br-Ph |
| 060 | H | H | H | H | 3-Br-Ph |
| 061 | H | H | H | H | 2-Cl-Ph |
| 062 | H | H | H | H | 3-Cl-Ph |
| 063 | H | H | H | H | 3,5-F₂-Ph |
| 064 | H | H | H | H | 3,5-Br₂-Ph |
| 065 | H | H | H | H | 3,5-Cl₂-Ph |
| 066 | H | H | H | H | 2,3-Cl₂-Ph |
| 067 | H | H | H | H | 2,4-Cl₂-Ph |
| 068 | H | H | H | H | 2,6-Cl₂-Ph |
| 069 | H | H | H | H | 3,4,5-Cl₃-Ph |
| 070 | H | H | H | H | 2,3,5-Cl₃-Ph |
| 071 | H | H | H | H | 3,4-(CH₃O)₂-Ph |
| 072 | H | H | H | H | 3,5-(CH₃)₂-Ph |
| 073 | H | H | H | H | 3-Cl-4-ON-Ph |
| 074 | H | H | H | H | 4-Cl-3-ON-Ph |
| 075 | H | H | H | H | 4-Br-2-F-Ph |
| 076 | H | H | H | H | 3-CH₃-4-CH₃O-Ph |
| 077 | H | H | H | H | 3-F-4-CH₃O-Ph |
| 078 | H | H | H | H | 4-F-Ph |
| 079 | H | H | H | CH₃ | 4-F-Ph |
| 080 | CH₃ | H | H | H | 4-F-Ph |
| 081 | CH₂CH₃ | H | H | H | 4-F-Ph |
| 082 | C₃H₇-i | H | H | H | 4-F-Ph |
| 083 | C₃H₅-cycl | H | H | H | 4-F-Ph |
| 084 | H | H | H | H | 4-Cl-Ph |
| 085 | H | H | H | CH₃ | 4-Cl-Ph |
| 086 | CH₃ | H | H | H | 4-Cl-Ph |
| 087 | CH₂CH₃ | H | H | H | 4-Cl-Ph |
| 088 | C₃H₇-i | H | H | H | 4-Cl-Ph |
| 089 | C₃H₅-cycl | H | H | H | 4-Cl-Ph |
| 090 | H | H | H | H | 4-Br-Ph |
| 091 | H | H | H | CH₃ | 4-Br-Ph |
| 092 | CH₃ | H | H | H | 4-Br-Ph |
| 093 | CH₂CH₃ | H | H | H | 4-Br-Ph |
| 094 | C₃H₇-i | H | H | H | 4-Br-Ph |
| 095 | C₃H₅-cycl | H | H | H | 4-Br-Ph |
| 096 | H | H | H | H | 4-CH₃-Ph |
| 097 | H | H | H | CH₃ | 4-CH₃-Ph |
| 098 | CH₃ | H | H | H | 4-CH₃-Ph |
| 099 | CH₂CH₃ | H | H | H | 4-CH₃-Ph |
| 100 | C₃H₇-i | H | H | H | 4-CH₃-Ph |
| 101 | C₃H₅-cycl | H | H | H | 4-CH₃-Ph |
| 102 | H | H | H | H | 4-CH₃—CH₂-Ph |
| 103 | H | H | H | CH₃ | 4-CH₃—CH₂-Ph |
| 104 | CH₃ | H | H | H | 4-CH₃—CH₂-Ph |
| 105 | CH₂CH₃ | H | H | H | 4-CH₃—CH₂-Ph |
| 106 | C₃H₇-i | H | H | H | 4-CH₃—CH₂-Ph |
| 107 | C₃H₅-cycl | H | H | H | 4-CH₃—CH₂-Ph |
| 108 | H | H | H | H | 3,4-F₂-Ph |
| 109 | H | H | H | CH₃ | 3,4-F₂-Ph |
| 110 | CH₃ | H | H | H | 3,4-F₂-Ph |
| 111 | CH₂CH₃ | H | H | H | 3,4-F₂-Ph |
| 112 | C₃H₇-i | H | H | H | 3,4-F₂-Ph |
| 113 | C₃H₅-cycl | H | H | H | 3,4-F₂-Ph |
| 114 | H | H | H | H | 3,4-Cl₂-Ph |
| 115 | H | H | H | CH₃ | 3,4-Cl₂-Ph |
| 116 | CH₃ | H | H | H | 3,4-Cl₂-Ph |
| 117 | CH₂CH₃ | H | H | H | 3,4-Cl₂-Ph |
| 118 | C₃H₇-i | H | H | H | 3,4-Cl₂-Ph |
| 119 | C₃H₅-cycl | H | H | H | 3,4-Cl₂-Ph |
| 120 | H | H | H | H | 3,4-Br₂-Ph |
| 121 | H | H | H | CH₃ | 3,4-Br₂-Ph |
| 122 | CH₃ | H | H | H | 3,4-Br₂-Ph |
| 123 | CH₂CH₃ | H | H | H | 3,4-Br₂-Ph |
| 124 | C₃H₇-i | H | H | H | 3,4-Br₂-Ph |
| 125 | C₃H₅-cycl | H | H | H | 3,4-Br₂-Ph |
| 126 | H | H | H | H | 3-Cl-4-F-Ph |
| 127 | H | H | H | CH₃ | 3-Cl-4-F-Ph |
| 128 | CH₃ | H | H | H | 3-Cl-4-F-Ph |
| 129 | CH₂CH₃ | H | H | H | 3-Cl-4-F-Ph |
| 130 | C₃H₇-i | H | H | H | 3-Cl-4-F-Ph |
| 131 | C₃H₅-cycl | H | H | H | 3-Cl-4-F-Ph |
| 132 | H | H | H | H | 4-Cl-3-F-Ph |
| 133 | H | H | H | CH₃ | 4-Cl-3-F-Ph |
| 134 | CH₃ | H | H | H | 4-Cl-3-F-Ph |
| 135 | CH₂CH₃ | H | H | H | 4-Cl-3-F-Ph |
| 136 | C₃H₇-i | H | H | H | 4-Cl-3-F-Ph |
| 137 | C₃H₅-cycl | H | H | H | 4-Cl-3-F-Ph |
| 138 | H | H | H | H | 3-Cl-4-CH₃-Ph |
| 139 | H | H | H | CH₃ | 3-Cl-4-CH₃-Ph |
| 140 | CH₃ | H | H | H | 3-Cl-4-CH₃-Ph |
| 141 | CH₂CH₃ | H | H | H | 3-Cl-4-CH₃-Ph |
| 142 | C₃H₇-i | H | H | H | 3-Cl-4-CH₃-Ph |
| 143 | C₃H_{5-cycl} | H | H | H | 3-Cl-4-CH₃-Ph |
| 144 | H | H | H | H | 4-Cl-3-CH₃-Ph |
| 145 | H | H | H | CH₃ | 4-Cl-3-CH₃-Ph |
| 146 | CH₃ | H | H | H | 4-Cl-3-CH₃-Ph |
| 147 | CH₂CH₃ | H | H | H | 4-Cl-3-CH₃-Ph |
| 148 | C₃H₇-i | H | H | H | 4-Cl-3-CH₃-Ph |
| 149 | C₃H₅-cycl | H | H | H | 4-Cl-3-CH₃-Ph |
| 150 | H | H | H | H | 3-Cl-4-CF₃-Ph |
| 151 | H | H | H | CH₃ | 3-Cl-4-CF₃-Ph |
| 152 | CH₃ | H | H | H | 3-Cl-4-CF₃-Ph |
| 153 | CH₂CH₃ | H | H | H | 3-Cl-4-CF₃-Ph |
| 154 | C₃H₇-i | H | H | H | 3-Cl-4-CF₃-Ph |
| 155 | C₃H₅-cycl | H | H | H | 3-Cl-4-CF₃-Ph |
| 156 | H | H | H | H | 4-Cl-3-CF₃-Ph |
| 157 | H | H | H | CH₃ | 4-Cl-3-CF₃-Ph |
| 158 | CH₃ | H | H | H | 4-Cl-3-CF₃-Ph |
| 159 | CH₂CH₃ | H | H | H | 4-Cl-3-CF₃-Ph |
| 160 | C₃H₇-i | H | H | H | 4-Cl-3-CF₃-Ph |
| 161 | C₃H₅-cycl | H | H | H | 4-Cl-3-CF₃-Ph |
| 162 | H | H | H | H | 4-Br-3-Cl-Ph |
| 163 | H | H | H | CH₃ | 4-Br-3-Cl-Ph |
| 164 | CH₃ | H | H | H | 4-Br-3-Cl-Ph |
| 165 | CH₂CH₃ | H | H | H | 4-Br-3-Cl-Ph |
| 166 | C₃H₇-i | H | H | H | 4-Br-3-Cl-Ph |
| 167 | C₃H₅-cycl | H | H | H | 4-Br-3-Cl-Ph |
| 168 | H | H | H | H | 3-Br-4-Cl-Ph |
| 169 | H | H | H | CH₃ | 3-Br-4-Cl-Ph |
| 170 | CH₃ | H | H | H | 3-Br-4-Cl-Ph |
| 171 | CH₂CH₃ | H | H | H | 3-Br-4-Cl-Ph |
| 172 | C₃H₇-i | H | H | H | 3-Br-4-Cl-Ph |
| 173 | C₃H₅-cycl | H | H | H | 3-Br-4-Cl-Ph |
| 174 | H | H | H | H | 3-Br-4-F-Ph |
| 175 | H | H | H | CH₃ | 3-Br-4-F-Ph |
| 176 | CH₃ | H | H | H | 3-Br-4-F-Ph |
| 177 | CH₂CH₃ | H | H | H | 3-Br-4-F-Ph |
| 178 | C₃H₇-i | H | H | H | 3-Br-4-F-Ph |
| 179 | C₃H₅-cycl | H | H | H | 3-Br-4-F-Ph |
| 180 | H | H | H | H | 4-Br-3-F-Ph |
| 181 | H | H | H | CH₃ | 4-Br-3-F-Ph |
| 182 | CH₃ | H | H | H | 4-Br-3-F-Ph |
| 183 | CH₂CH₃ | H | H | H | 4-Br-3-F-Ph |
| 184 | C₃H₇-i | H | H | H | 4-Br-3-F-Ph |
| 185 | C₃H₅-cycl | H | H | H | 4-Br-3-F-Ph |
| 186 | H | H | H | H | 3-Br-4-CH₃-Ph |
| 187 | H | H | H | CH₃ | 3-Br-4-CH_{3-Ph} |
| 188 | CH₃ | H | H | H | 3-Br-4-CH₃-Ph |
| 189 | CH₂CH₃ | H | H | H | 3-Br-4-CH₃-Ph |
| 190 | C₃H₇-i | H | H | H | 3-Br-4-CH₃-Ph |
| 191 | C₃H₅-cycl | H | H | | 3-Br-4-CH₃-Ph |
| 192 | H | H | H | H | 4-Br-3-CH₃-Ph |
| 193 | H | H | H | CH₃ | 4-Br-3-CH₃-Ph |
| 194 | CH₃ | H | H | H | 4-Br-3-CH₃-Ph |
| 195 | CH₂CH₃ | H | H | H | 4-Br-3-CH₃-Ph |
| 196 | C₃H₇-i | H | H | H | 4-Br-3-CH₃-Ph |
| 197 | C₃H₅-cycl | H | H | H | 4-Br-3-CH₃-Ph |
| 198 | H | H | H | H | 4-CF₃-Ph |
| 199 | H | H | H | CH₃ | 4-CF₃-Ph |
| 200 | CH₃ | H | H | H | 4-CF₃-Ph |
| 201 | CH₂CH₃ | H | H | H | 4-CF₃-Ph |
| 202 | C₃H₇-i | H | H | H | 4-CF₃-Ph |
| 203 | C₃H₅-cycl | H | H | H | 4-CF₃-Ph |
| 204 | H | H | H | H | 4-CF₃O-Ph |
| 205 | H | H | H | CH₃ | 4-CF₃O-Ph |
| 206 | CH₃ | H | H | H | 4-CF₃O-Ph |
| 207 | CH₂CH₃ | H | H | H | 4-CF₃O-Ph |
| 208 | C₃H₇-i | H | H | H | 4-CF₃O-Ph |
| 209 | C₃H₅-cycl | H | H | H | 4-CF₃O-Ph |
| 210 | H | H | H | H | 3,4-(CH₃)₂-Ph |
| 211 | H | H | H | CH₃ | 3,4-(CH₃)₂-Ph |
| 212 | CH₃ | H | H | H | 3,4-(CH₃)₂-Ph |
| 213 | CH₂CH₃ | H | H | H | 3,4-(CH₃)₂-Ph |
| 214 | C₃H₇-i | H | H | H | 3,4-(CH₃)₂-Ph |
| 215 | C₃H₅-cycl | H | H | H | 3,4-(CH₃)₂-Ph |
| 216 | H | H | H | H | 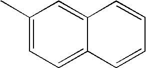 |
| 217 | H | H | H | CH₃ | 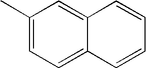 |
| 218 | CH₃ | H | H | H | 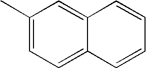 |
| 219 | CH₂CH₃ | H | H | H | 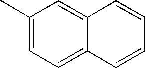 |
| 220 | C₃H₇-i | H | H | H | 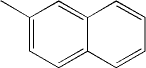 |
| 221 | C₃H₅-cycl | H | H | H | 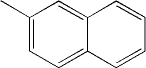 |
| 222 | H | H | H | H | 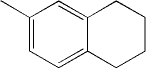 |
| 223 | H | H | H | CH₃ | 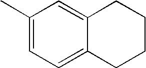 |
| 224 | CH₃ | H | H | H | 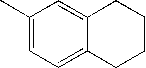 |
| 225 | CH₂CH₃ | H | H | H | 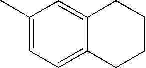 |
| 226 | C₃H₇-i | H | H | H | 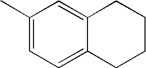 |
| 227 | C₃H₅-cycl | H | H | H | 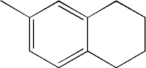 |
| 228 | H | H | H | H | 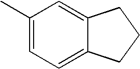 |
| 229 | H | H | H | CH₃ | 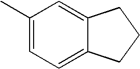 |
| 230 | CH₃ | H | H | H | 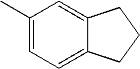 |
| 231 | CH₂CH₃ | H | H | H | 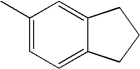 |
| 232 | C₃H₇-i | H | H | H | 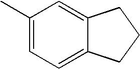 |
| 233 | C₃H₅-cycl | H | H | H | 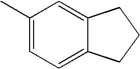 |
| 234 | H | H | H | H | 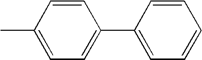 |
| 235 | H | H | H | CH₃ | 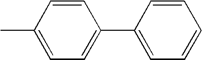 |
| 236 | CH₃ | H | H | H | 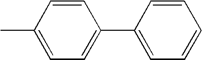 |
| 237 | CH₂CH₃ | H | H | H | 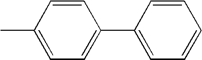 |
| 238 | C₃H₇-i | H | H | H | 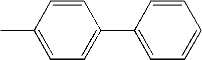 |
| 239 | C₃H₅-cycl | H | H | H | 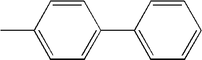 |
| 240 | H | H | H | H | 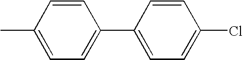 |
| 241 | H | H | H | H | 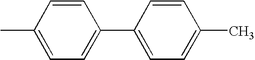 |
| 242 | H | H | H | H | 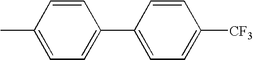 |
| 243 | H | H | H | H | 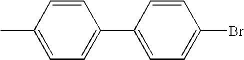 |
| 244 | H | H | H | H | 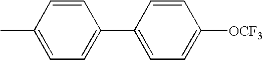 |
| 245 | H | H | H | H | 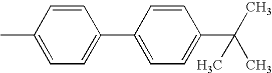 |
| 246 | H | H | H | 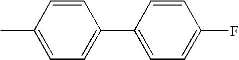 | |
| 247 | H | H | H | 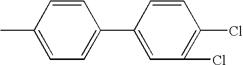 | |
| 248 | H | H | H | H | 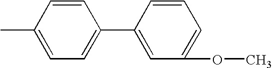 |
| 249 | H | H | H | H | 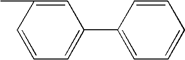 |
| 250 | H | H | H | H | 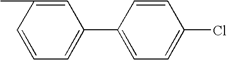 |

(Ph designates phenyl)

### Biological Examples

### D-1: Action against Plasmopara viticola on vines

a) Residual-protective action

Vine seedlings are sprayed at the 4- to 5-leaf stage with a spray mixture (0.02% active ingredient) prepared from a wettable powder formulation of the test compound. After 24 hours, the treated plants are infected with a sporangia suspension of the fungus. Fungus infestation is evaluated after incubation for 6 days at 95-100% relative humidity and +20° C.

b) Residual-Curative Action

Vine seedlings are infected at the 4- to 5-leaf stage with a sporangia suspension of the fungus. After incubation for 24 hours in a humidity chamber at 95-100% relative humidity and +20° C., the infected plants are dried and sprayed with a spray mixture (0.02% active ingredient) prepared from a wettable powder formulation of the test compound. After the spray coating has dried, the treated plants are placed in the humidity chamber again. Fungus infestation is evaluated 6 days after infection.

Compounds of Tables 1 to 31 exhibit a good fungicidal action against Plasmopara viticola on vines. Compounds E1.002, E1.011 and E1.152 at 200 ppm inhibit fungal infestations in both tests D-1a) and D-1b) by 80-100%. At the same time untreated plants showed pathogen attack of 80-100%.

### D-2: Action against Phytophthora on tomato plants

a) Residual-protective action

After a cultivation period of 3 weeks, tomato plants are sprayed with a spray mixture (0.02% active ingredient) prepared from a wettable powder formulation of the test compound. After 48 hours, the treated plants are infected with a sporangia suspension of the fungus. Fungus infestation is evaluated after incubation of the infected plants for 5 days at 90-100% relative humidity and +20° C.

b) Systemic action

After a cultivation period of 3 weeks, tomato plants are watered with a spray mixture (0.02% active ingredient based on the volume of the soil) prepared from a wettable powder formulation of the test compound. Care is taken that the spray mixture does not come into contact with the parts of the plants that are above the ground. After 96 hours, the treated plants are infected with a sporangia suspension of the fungus. Fungus infestation is evaluated after incubation of the infected plants for 4 days at 90-100% relative humidity and +20° C.

Compounds of Tables 1 to 31 exhibit a long-lasting effect against fungus infestation. Compounds E1.002, E1.011, E1.151 and E1.152 at 200 ppm inhibit fungal infestations in both tests D-2a) and D-2b) by 80-100%. At the same time untreated plants showed pathogen attack of 80-100%.

### D-3: Action against Phytophthora on potato plants

a) Residual-protective action

2-3 week old potato plants (Bintje variety) are sprayed with a spray mixture (0.02% active ingredient) prepared from a wettable powder formulation of the test compound. After 48 hours, the treated plants are infected with a sporangia suspension of the fungus. Fungus infestation is evaluated after incubation of the infected plants for 4 days at 90-100% relative humidity and +20° C.

b) Systemic action

2-3 week old potato plants (Bintje variety) are watered with a spray mixture (0.02% active ingredient based on the volume of the soil) prepared from a wettable powder formulation of the test compound. Care is taken that the spray mixture does not come into contact with the parts of the plants that are above the ground. After 48 hours, the treated plants are infected with a sporangia suspension of the fungus. Fungus infestation is evaluated after incubation of the infected plants for 4 days at 90-100% relative humidity and +20° C. Fungal infestation is effectively controlled with compounds of Tables 1 to 31.

Compounds E1.002, E1.011 and E1.152 at 200 ppm inhibit fungal infestations in both tests D-3a) and D-3b) by 80-100%. At the same time untreated plants showed pathogen attack of 80-100%.

1. The compounds of formula I 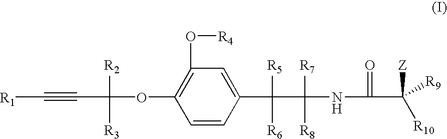
including the optical isomers thereof and mixtures of such isomers, wherein
R₁ is hydrogen, alkyl, cycloalkyl or optionally substituted aryl,
R₂ and R₃ are each independently hydrogen or alkyl,
R₄ is alkyl, alkenyl or alkynyl,
R₅, R₆, R₇, and R₈ are each independently hydrogen or alkyl,
R₉ is hydrogen, optionally substituted alkyl, optionally substituted alkenyl or optionally substituted alkynyl,
R₁₀ is optionally substituted aryl or optionally substituted heteroaryl, and
Z is optionally substituted aryloxy, optionally substituted alkoxy, optionally substituted alkenyloxy or optionally substituted alkynyloxy

2. A compound according to claim 1, wherein the enantio-enriched form of the compound of formula I contains the pure enantiomer as displayed in an amount of at least 70%.

3. A compound according to claim 1, wherein the contents of the entio-enriched form contains the pure enantiomer as displayed in an amount of at least 80%, preferably above 90%, especially above 95%.

4. A compound according to claim 1, wherein
R₁ is hydrogen, alkyl, cycloalkyl, phenyl or naphthyl; phenyl and naphthyl being optionally substituted by substituents selected from the group comprising alkyl, alkenyl, alkynyl, cycloalkyl, cycloalkyl-alkyl, phenyl and phenylalkyl, where all these groups may in turn be substituted by one or several halogens; alkoxy, alkenyloxy, alkynyloxy; alkoxy-alkyl; haloalkoxy; alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; or alkynyloxycarbonyl; and
R₂ and R₃ are independently of each other hydrogen or C₁-C₄alkyl; and
R₄ is C₁-C₈alkyl, C₂-C₈alkenyl, or C₂-C₈alkynyl; and
R₅, R₆, R₇ and R₈ are independently of each other hydrogen or C₁-C₄alkyl; and
R₉ is hydrogen, C₁-C₄alkyl, C₁-C₄haloalkyl, C₃-C₄alkenyl or C₃-C₄alkynyl; and
R₁₀ is aryl or heteroaryl, each optionally substituted with substituents selected from to group comprising alkyl, alkenyl, alkynyl, cycloalkyl, cycloalkyl-alkyl, phenyl and phenylalkyl, where all these groups may be substituted with one or more substituents selected from the group comprising halogen; alkoxy, alkenyloxy, alkynyloxy; alkoxy-alkyl; haloalkoxy; alkylthio; haloalkylthio; alkylsulfonyl; formyl; alkanoyl; hydroxy; cyano; nitro; amino; alkylamino; dialkylamino; carboxyl; alkoxycarbonyl; alkenyloxycarbonyl and alkynyloxycarbonyl; and
Z is optionally substituted aryloxy wherein the aryl may be optionally substituted by one or more substituents selected from the group comprising halogen, C₁-C₈alkoxy, C₂-C₈alkenyloxy, C₂-C₈alkynyloxy, C₁-C₈alkoxy-C₁-C₈alkyl, C₁-C₈haloalkoxy, C₁-C₈alkylthio, C₁-C ₈haloalkylthio, C₁-C₈alkylsulfonyl, formyl, C₂-C₈alkanoyl, hydroxy, halogen, cyano, nitro, amino, C₁-C₈alkylamino, di- C₁-C₈alkylamino, carboxyl and C₁-C₈alkoxycarbonyl; or is optionally substituted C₁-C₈alkoxy, optionally substituted C₂-C₈alkenyloxy or optionally substituted C₂-C₈alkynyloxy, wherein each alkyl, alkenyl or alkynyl group may carry one or more substituents selected from the group comprising halogen, C₁-C₄alkyl, C₁-C₄alkoxy, C₁-C₄alkylthio, C₃-C₆cycloalkyl, nitro, cyano, hydroxy, phenyl, mercapto, C₁-C₄alkylcarbonyl and C₁-C₄alkoxycarbonyl.

5. A compound according to claim 1, wherein
R₁ is hydrogen, C₁-C₈alkyl, C₃-C₈cycloalkyl, phenyl or naphthyl; phenyl and naphthyl being optionally substituted by one to three substituents selected from the group comprising C₁-C₈alkyl, C₂-C₈alkenyl, C₂-C₈alkynyl, C₁-C₈haloalkyl, C₁-C₈alkoxy, C₁-C₈haloalkoxy, C₈haloalkylthio, C₁-C₈alkylsulfonyl, halogen, cyano, nitro and C₁-C₈alkoxycarbonyl; and R₂ and R₃ are hydrogen; and R4 is C₁-C₆alkyl; and R₅, R6 and R₇ are hydrogen and R8 is hydrogen, methyl or ethyl; and R₉ is hydrogen or C₁-C₄alkyl; and R₁₀ is phenyl, naphthyl or biphenyl, each optionally substituted by one to three substituents selected from the group comprising C₁-C₈alkyl, C₂-C₈alkenyl, C₂-C₈alkynyl, C₂-C₈alkylnyl, C₁-C₈haloalkyl, C₁-C₈alkoxy, C₁-C₈haloalkoxy, C₁-C₈alkylthio, C₁-C₈haloalkylthio, C₁-C₈alkylsulfonyl, halogen, cyano, nitro and C₁-C₈alkoxycarbonyl; and Z is C₁-C₈alkoxy, C₂-C₈alkenyloxy, C₁-C₈alkynyloxy, C₁-C₈alkoxy-C₁-C₈alkoxy, C₂-C₈alkenyloxy-C₁-C₈alkoxy, C₂-C₈alkynyloxy-C₁-C₈alkoxy, C₁-C₈haloalkoxy or C₃-C₈cycloalkyl-C₁-C₈alkoxy.

6. A compound of formula I according to claim 1, wherein R₁ is hydrogen, C₁-C₈alkyl or phenyl optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and R₂ and R₃ are hydrogen; and R₄ is C₁-C₄alkyl, and R₅, R₆ and R₇ are hydrogen and R₈ is hydrogen or methyl; and R₉ is hydrogen; and R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl; and Z is C₁-C₈alkoxy, C₂-C₈alkenyloxy, C₂-C₈alkynyloxy or C₁-C₄alkoxy-C₁-C₂alkoxy.

7. A compound of formula I according to claim 1, wherein R₁ is hydrogen, C₁-C₈alkyl or C₃-C₈cycloalkyl; and R₂, R₃, R₅, R₆, R₇, R₈ and R₉ are hydrogen; and R₄ is methyl or ethyl; and R₁₀ is phenyl, naphthyl, 1,3-biphenyl or 1,4-biphenyl, each optionally substituted by one to three substituents selected from the group comprising C₁-C₈alkyl, C₁-C₈haloalkyl, C₁-C₈alkoxy, C₁-C₈haloalkoxy, C₁-C₈alkylthio, C₁-C₈haloalkylthio, halogen, cyano, nitro and C₁-C₈alkoxycarbonyl.

8. A compound of formula I according to claim 1 selected from the group comprising
(S)-2-(4-bromo-phenyl)-2-methoxy-N-[2-(3-methoxy-4-prop-2-ynyloxy-phenyl)-ethyl]-acetamide,
(S)-2-(4-chloro-phenyl)-2-methoxy-N-[2-(3-methoxy-4-prop-2-ynyloxy-phenyl)-ethyl]-acetamide,
(S)-2-(3,4-dichloro-phenyl)-2-methoxy-N-[2-(3-methoxy-4-prop-2-ynyloxy-phenyl)-ethyl]-acetamide,
(S)-2-(4-bromo-phenyl)-2-ethoxy-N-[2-(3-methoxy-4-prop-2-ynyloxy-phenyl)-ethyl]-acetamide,
(S)-2-(4-chloro-phenyl)-2-ethoxy-N-[2-(3-methoxy-4-prop-2-ynyloxy-phenyl)-ethyl]-acetamide,
(S )-2-(3,4-dichloro-phenyl )-2-ethoxy-N-[2-(3-methoxy-4-prop-2-ynyloxy-phenyl )-ethyl]-acetamide,
(S)-2-(4-bromo-phenyl)-N-[2-(3-methoxy4-prop-2-ynyloxy-phenyl)-ethyl]-2-propoxy-acetamide,
(S)-2-(4-chloro-phenyl)-N-[2-(3-methoxy4-prop-2-ynyloxy-phenyl)-ethyl]-2-propoxy-acetamide,
(S)-2-(3,4-dichloro-phenyl)-N-[2-(3-methoxy-4-prop-2-ynyloxy-phenyl)-ethyl]-2-propoxy-acetamide,
(S)-2-(4-bromo-phenyl)-2-cyclopropylmethoxy-N-[2-(3-methoxy-4-prop-2-ynyloxy-phenyl)-ethyl]-acetamide,
(S)-2-(4-chloro-phenyl)-2-cyclopropylmethoxy-N-[2-(3-methoxy-4-prop-2-ynyloxy-phenyl)-ethyl]-acetamide,
(S)-2-cyclopropylmethoxy-2-(3,4-dichloro-phenyl)-N-[2-(3-methoxy4-prop-2-ynyloxy-phenyl)-ethyl]-acetamide,
(S)-2-(4-bromo-phenyl)-2-ethoxymethoxy-N-[2-(3-methoxy-4-prop-2-ynyloxy-phenyl)-ethyl]-acetamide,
(S)-2-(4-chloro-phenyl)-2-ethoxymethoxy-N-[2-(3-methoxy4-prop-2-ynyloxy-phenyl)-ethyl]-acetamide,
(S)-2-(3,4-dichloro-phenyl)-2-ethoxymethoxy-N-[2-(3-methoxy4-prop-2-ynyloxy-phenyl)-ethyl]-acetamide,
(S)-2-allyloxy-2-(4-bromo-phenyl)-N-[2-(3-methoxy4-prop-2-ynyloxy-phenyl)-ethyl]-acetamide,
(S)-2-allyloxy-2-(4-chloro-phenyl)-N-[2-(3-methoxy4-prop-2-ynyloxy-phenyl)-ethyl]-acetamide,
(S)-2-allyloxy-2-(3,4-dichloro-phenyl)-N-[2-(3-methoxy4-prop-2-ynyloxy-phenyl)-ethyl]-acetamide,
(S)-2-(4-bromo-phenyl)-2-(but-2-enyloxy)-N-[2-(3-methoxy4-prop-2-ynyloxy-phenyl)-ethyl ]-acetamide,
(S)-2-(but-2-enyloxy)-2-(4-chloro-phenyl)-N-[2-(3-methoxy4-prop-2-ynyloxy-phenyl)-ethyl ]-acetamide,
(S)-2-(but-2-enyloxy)-2-(3,4-dichloro-phenyl)-N-[2-(3-methoxy4-prop-2-ynyloxy-phenyl)-ethyl]-acetamide,
(S)-2-(4-bromo-phenyl)-N-[2-(3-methoxy4-prop-2-ynyloxy-phenyl)-ethyl]-2-prop-2-ynyloxy-acetamide,
(S)-2-(4-chloro-phenyl)-N-[2-(3-methoxy-4-prop-2-ynyloxy-phenyl)-ethyl]-2-prop-2-ynyloxy-acetamide,
(S)-2-(3,4-dichloro-phenyl)-N-[2-(3-methoxy4-prop-2-ynyloxy-phenyl)-ethyl]-2-prop-2-ynyloxy acetamide,
(S)-2-biphenyl4-yl-N-[2-(3-methoxy-4-prop-2-ynyloxy-phenyl)-ethyl]-2-prop-2-ynyloxy-acetamide,
(S)-N-[2-(3-methoxy-4-prop-2-ynyloxy-phenyl)-ethyl]-2-naphthalen-2-yl-2-prop-2-ynyloxy-acetamide,
(S)-N-[2-(3-methoxy-4-prop-2-ynyloxy-phenyl)-ethyl]-2-prop-2-ynyloxy-2-p-tolyl-acetamide,
2-(4-ethyl-phenyl)-N-[2-(3-methoxy-4-prop-2-ynyloxy-phenyl)-ethyl]-2-prop-2-ynyloxy-acetamide,
(S)-N-[2-(3-methoxy-4-prop-2-ynyloxy-phenyl)-ethyl]-2-prop-2-ynyloxy-2-(4-trifluoromethyl-phenyl)-acetamide,
(S)-2-(4-bromo-phenyl)-2-but-2-ynyloxy-N-[2-(3-methoxy4-prop-2-ynyloxy-phenyl)-ethyl]-acetamide,
(S)-2-but-2-ynyloxy-2-(4-chloro-phenyl)-N-[2-(3-methoxy-4-prop-2-ynyloxy-phenyl)-ethyl]-acetamide,
(S)-2-but-2-ynyloxy-2-(3,4-dichloro-phenyl)-N-[2-(3-methoxy-4-prop-2-ynyloxy-phenyl) -ethyl]acetamide,
(S)-2-(4-bromo-phenyl)-N-[2-(3-methoxy4-pent-2-ynyloxy-phenyl)-ethyl]-2-prop-2-ynyloxy-acetamide,
(S)-2-(4-chloro-phenyl)-N-[2-(3-methoxy4-pent-2-ynyloxy-phenyl)-ethyl]-2-prop-2-ynyloxy-acetamide,
(S )-2-(3,4-dichloro-phenyl )-N-[2-(3-methoxy4-pent-2-ynyloxy-phenyl)-ethyl]-2-prop-2-ynyloxy-acetamide,
(S)-2-(4-fluoro-phenyl)-N-[2-(3-methoxy4-prop-2-ynyloxy-phenyl)-ethyl]-2-prop-2-ynyloxy-acetamide,
(S)-2-(3,4-difluoro-phenyl)-N-[2-(3-methoxy4-prop-2-ynyloxy-phenyl)-ethyl]-2-prop-2-ynyloxy-acetamide,
(S)-2-(4-chloro-3-fluoro-phenyl)-N-[2-(3-methoxy4-prop-2-ynyloxy-phenyl)-ethyl]-2-prop-2-ynyloxy-acetamide, and
(S)-2-(3-chloro4-fluoro-phenyl)-N-[2-(3-methoxy4-prop-2-ynyloxy-phenyl)-ethyl]-2-prop-2-ynyloxy-acetamide.

9. A process for the preparation of a compound of formula I according to claim 1, which comprises reacting
a) the phenol of formula IV 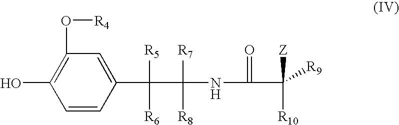
wherein R₄, R₅, R₆, R₇, R₈, R₉, R₁₀ and Z are as defined for formula I with a compound of formula V 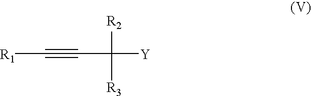
wherein R₁, R₂ and R₃ are as defined for formula I and wherein Y is a leaving group; or
b) the acid of formula II 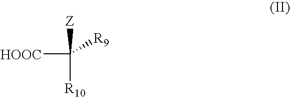
with an amine of formula VI 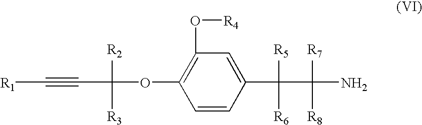
wherein R₁, R₂, R₃, R₄, R₅, R₆, R₇, R₈, R₉ and R₁₀ are as defined for formula I.

10. A composition for controlling and protecting against phytopathogenic microorganisms, comprising a compound of formula I according to claim 1 as active ingredient together with a suitable carrier.

11. A composition according to claim 10, which comprises at least one additional fungicidally active compound, preferably selected from the group consisting of cymoxanil, trifloxystrobin, azoxystrobin, picoxystrobin, chlorothalonil, metalaxyl, metalaxyl-M, pyraclostrobin (BAS500F), dimethomorph, fosetyl-AI, copper-salts, acibenzolar-S-methyl, fludioxonil, mancozeb, folpet, fluazinam, iprovalicarb, zoxamid and (S)-2-(methylsulfonyl-amino)-3-methyl-butyric acid N-[2-{3-methoxy-4-(3-(4-chlorophenyl)-2-propyn-1-yloxy)-phenyl}-ethyl]-amide.

12. (Cancelled).

13. A method of controlling and preventing an infestation of crop plants by phytopathogenic microorganisms, which comprises the application of a compound of formula I according to claim 1 as active ingredient to the plant, to parts of plants or to the locus thereof.

14. A method according to claim 13, wherein the phytopathogenic microorganisms are fungal organisms.

15. A process for the preparation of a compound of formula la according to claim 1 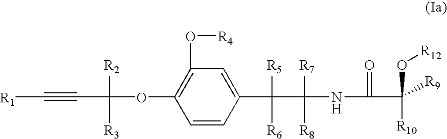
wherein R₁, R₂, R₃, R₄, R₅, R₆, R₇, R₈, R₉ and R₁₀ are as defined for formula I in claim 1 and R₁₂ is alkyl, alkenyl or alkynyl, which process comprises reacting a compound of formula XIII 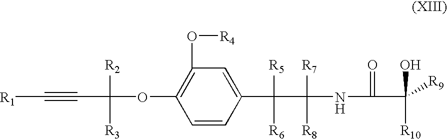
with a compound of formula XIV
Y—R₁₂ (XIV)
wherein R₁₂ is alkyl, alkenyl or alkynyl and Y is a leaving group, e.g. bromine or chlorine or a tosyl, mesyl or trifluoromethylsulfonyl.

16. A process for the preparation of a compound of formula Ib according to claim 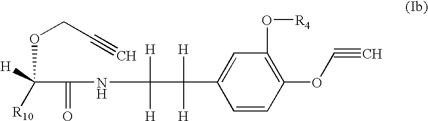
which comprises reacting a compound of formula 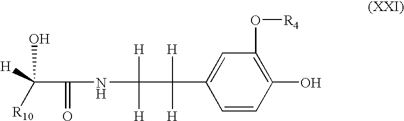
wherein R₄ and R₁₀ are as defined for formula I in claim 1, with a propargylating agent of formula XXII
Y—CH₂—≡CH (XXII)
wherein Y is a leaving group, e.g. bromine or chlorine or a tosyl, mesyl or trifluoromethylsulfonyl.
